(19) United States
(12) Patent Application Publication
(10) Pub. No.: US 2026/0279749 A1
(43) Pub. Date: Sep. 17, 2026

(54) RAPID MASS ANALYZER CALIBRATION VIA INITIAL TIME AND PHASE PREDICTION

(71) Applicant: Thermo Fisher Scientific (Bremen) GmbH, Bremen (DE)

(72) Inventor: Amelia Corinne Peterson, Aalen (DE)

(21) Appl. No.: 19/081,522

(22) Filed: Mar. 17, 2025

(51) Int. Cl. H01J 49/00

(52) U.S. Cl. CPC H01J 49/0009

(57) ABSTRACT

Systems/techniques are provided for facilitating rapid mass analyzer calibration via initial time and phase prediction. In various embodiments, a system can access a mass analyzer. In various aspects, the system can calibrate the mass analyzer, based on predicting an initial time and an initial phase of the mass analyzer via at least one fitted model. In various instances, the system can predict the initial time and the initial phase based on feeding a current operational parameter configuration of the mass analyzer as input to the at least one fitted model.

### BACKGROUND

Calibrating a mass analyzer can be considered as a time-consuming task.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate rapid mass analyzer calibration via initial time and phase prediction are described.

According to one or more embodiments, a system is provided. The system can comprise a non-transitory computer-readable memory that can store computer-executable components. The system can further comprise a processor that can be operably coupled to the non-transitory computer-readable memory and that can execute the computer-executable components stored in the non-transitory computer-readable memory. In various embodiments, the computer-executable components can comprise an access component that can access a mass analyzer. In various aspects, the computer-executable components can comprise a calibration component that can calibrate the mass analyzer, based on predicting an initial time and an initial phase of the mass analyzer via at least one fitted model. In various instances, the calibration component can predict the initial time and the initial phase based on feeding a current operational parameter configuration of the mass analyzer as input to the at least one fitted model.

According to one or more embodiments, a computer-implemented method is provided. In various embodiments, the computer-implemented method can comprise accessing, by a device operatively coupled to a processor, a mass analyzer. In various aspects, the computer-implemented method can include calibrating, by the device, the mass analyzer, based on predicting an initial time and an initial phase of the mass analyzer via at least one fitted model. In various instances, the device can predict the initial time and the initial phase based on feeding a current operational parameter configuration of the mass analyzer as input to the at least one fitted model.

According to one or more embodiments, a computer program product for facilitating rapid mass analyzer calibration via initial time and phase prediction is provided. In various embodiments, the computer program product can comprise a non-transitory computer-readable memory having program instructions embodied therewith. In various aspects, the program instructions can be executable by a processor to cause the processor to access a mass analyzer. In various instances, the program instructions can be further executable to cause the processor to calibrate the mass analyzer, based on predicting an initial time and an initial phase of the mass analyzer via at least one fitted model. In various cases, the processor can predict the initial time and the initial phase based on feeding a current operational parameter configuration of the mass analyzer as input to the at least one fitted model.

### DESCRIPTION OF THE DRAWINGS

Various embodiments will be readily understood by the following detailed description in conjunction with the accompanying figures. To facilitate this description, like reference numerals designate like structural elements. Embodiments are illustrated by way of example, not by way of limitation, in the figures. The figures are not necessarily drawn to scale.

FIG. 1 illustrates an example, non-limiting block diagram of a scientific instrument module in accordance with various embodiments described herein.

FIG. 2 illustrates an example, non-limiting flow diagram of a computer-implemented method in accordance with various embodiments described herein.

FIG. 3 illustrates a block diagram of an example, non-limiting system that facilitates rapid mass analyzer calibration via initial time and phase prediction in accordance with one or more embodiments described herein.

FIG. 4 illustrates a block diagram of an example, non-limiting system including at least one fitted model, a determined initial time, a determined initial phase, and a determined frequency-to-mass coefficient that facilitates rapid mass analyzer calibration via initial time and phase prediction in accordance with one or more embodiments described herein.

FIGS. 5-14 illustrate example, non-limiting block diagrams showing how at least one fitted model can be leveraged to generate a determined initial time, a determined initial phase, and a determined frequency-to-mass coefficient in accordance with one or more embodiments described herein.

FIG. 15 illustrates a block diagram of an example, non-limiting system including a sample and a mass spectrum that facilitates rapid mass analyzer calibration via initial time and phase prediction in accordance with one or more embodiments described herein.

FIG. 16 illustrates a flow diagram of an example, non-limiting computer-implemented method that facilitates rapid mass analyzer calibration via initial time and phase prediction in accordance with one or more embodiments described herein.

FIGS. 17-21 illustrate example, non-limiting experimental results in accordance with one or more embodiments described herein.

FIG. 22 illustrates a block diagram of an example, non-limiting operating environment in which one or more embodiments described herein can be facilitated.

FIG. 23 illustrates an example networking environment operable to execute various implementations described herein.

### DETAILED DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details. It is also evident that new embodiments can be created by combining the embodiments described herein and/or by omitting certain features from the embodiments described therein, as appropriate.

Various operations can be described as multiple discrete actions or operations in turn, in a manner that is most helpful in understanding the subject matter disclosed herein. However, the order of description should not be construed as to imply that these operations are necessarily order dependent. In particular, these operations can be performed in an order different from the order of presentation. Operations described can be performed in a different order from the described embodiments. Various additional operations can be performed, or described operations can be omitted in additional embodiments.

Although some elements may be referred to in the singular (e.g., “a processing device”), any appropriate elements may be represented by multiple instances of that element, and vice versa. For example, a set of operations described as performed by a processing device may be implemented with different ones of the operations performed by different processing devices. As used herein, the phrase “based on” should be understood to mean “based at least in part on,” unless otherwise specified.

A mass spectrometer coupled to a chromatograph can be considered as a type of scientific instrument that can be deployed in a scientific, laboratory, research, or clinical operational context or setting, so as to determine the chemical composition or make-up of unknown samples. To facilitate such chemical composition determination, the mass spectrometer or chromatograph can comprise a complex arrangement of actuatable parts (e.g., ion sources, ion lenses, heaters, coolers, columns, ovens, injectors, mass analyzers, fluid valves, fluid pumps, circuit switches), sensors (e.g., ion detectors, voltmeters, thermistors, potentiometers, pressure gauges), or consumables (e.g., carrier fluids, calibrants, filters).

A mass analyzer can be considered as a particularly complicated constituent component of a mass spectrometer. A mass analyzer separates (or, in some cases, measures without physically separating) ions based on their mass-to-charge ratios (based on their m/z values), so that whatever chemical species make up a sample or specimen can be identified or quantified. Different mass analyzers exhibit different physical constructions, designs, or operating principles (e.g., quadrupole mass analyzers versus time-of-flight mass analyzers versus orbital trapping mass analyzers). In order for a mass analyzer to operate properly (e.g., to correctly, accurately, or reliably distinguish ions according to their mass-to-charge ratios), the mass analyzer should first be calibrated. For a mass analyzer that is configured to perform enhanced Fourier Transform (eFT) scans, such calibration can involve determination of initial ion phase at point of ion injection into the mass analyzer, as well as determination of a frequency-domain-to-mass-domain mapping for the mass analyzer.

More specifically, a mass analyzer can employ, be made up of, or otherwise be associated with (e.g., be downstream of) ion trapping hardware which can accumulate ions that are emitted by or that originate from some ion source. Once a threshold number of ions are stored or accumulated in the ion trapping hardware, those ions can be squeezed or compressed (e.g., via appropriate electrode manipulation) to a common point and then be ejected (e.g., via appropriate electrode manipulation) from the ion trapping hardware, such that those ions fly or travel into the mass analyzer. Such flight or traveling can consume a non-zero amount of time, meaning that there can be a temporal delay between ejection of the ions by the ion trapping hardware and detection of the ions by the mass analyzer. Those ions can begin by having the same phase as each other (e.g., at least in mass analyzers that utilize an excitation-by-injection mechanism), and, during that temporal delay, the phase of the ions grows or exacerbates.

For additional clarity, consider the following brief discussion of excitation-by-injection mass analyzers. For a mass analyzer that utilizes excitation-by-injection, a quasi-continuous ion beam enters a gas-filled C-trap (an ion trap composed of rod electrodes curved concavely toward the mass analyzer entrance), where ions collide with bath gas, lose energy and are stored. After the radio frequency (RF) voltage applied to the C-trap electrodes is ramped down, a radial direct current (DC) potential is applied across the electrodes, and ions are ejected along lines converging on the mass analyzer entrance. As ions enter the mass analyzer as small packets, increasing voltage on the central electrode “squeezes” ions, forcing them at the same time to move towards the center of the trap and thus exciting axial oscillations. Ion injection methods for injecting ions into the mass analyzer often involve changing the trapping field during injection so that the oscillation frequencies of the ions during this initial injection period are also changing. The time-of-flight from the C-trap to the mass analyzer is proportional to the square root of mass-to-charge ratio, while axial frequency is proportional to the reciprocal of the square root of mass-to-charge ratio. So, the phase acquired by ions traveling along an effective length from the C-trap to the mass analyzer becomes mass-independent in a first-order approximation.

In any case, the mass analyzer can, in response to detection of ions, produce a time-domain signal, which can be considered as a collection of time-intensity tuples (e.g., measured or detected intensity at each respective point in time). That time-domain signal can be converted into a frequency-domain spectrum (e.g., a collection of frequency-intensity tuples) via application of a Fourier Transform. During application of the Fourier Transform, each time-intensity tuple can be decomposed into a respective real part and a respective imaginary part (or, when expressed in polar coordinates, a respective phase and a respective magnitude). Absorption and dispersion spectra can be calculated from the real and imaginary parts, respectively. Oftentimes, these absorption and dispersion spectra are asymmetric and thus of limited practical use or value. In situations where determination or control of initial ion phase at point of ejection from the ion trapping hardware is unavailable, the phase information can be discarded, and symmetric/useful absorption spectra can be obtained in a magnitude-only fashion. Doing so, however, comes at a cost of 1.4-times to 2-times lower resolving power.

For orbital trapping mass analyzers, eFT signal processing was developed, which combines phase-aware absorption spectra and phase-naïve magnitude spectra to produce robust frequency-domain spectra having high resolution. To accomplish this, eFT signal processing makes use of the excitation-by-injection mechanism that is characteristic of orbital trapping mass analyzers, which synchronizes ion motion (and thus phase) at the point of injection. Furthermore, eFT signal processing also makes use of the fact that acquired phase that develops as ions travel or fly from ion trapping hardware to orbital trapping mass analyzers is approximately mass-independent. Together with precise determination of time of ejection/excitation by extrapolating sinusoids backwards to whichever time at which their phase shifts are minimized, eFT signal processing is able to create high-fidelity spectra in the frequency-domain.

When given a frequency spectrum, a corresponding mass spectrum (e.g., a corresponding collection of m/z-intensity tuples) can be calculated using an orbital trapping mass analyzer's theoretical relationship between peak frequency (denoted @) and peak mass-to-charge ratio (denoted m/z):

$$\frac{m}{z} = \frac{k}{{ω}^{2}}$$

where k represents an experimentally determined calibration coefficient. Note that the above formula can be considered as a first-order mapping between frequency and mass-to-charge ratio. In practice, to ensure low mass error (e.g., <3 parts per million) across whatever analytical mass range is being implemented by the mass analyzer, corrections from higher-order mappings can be implemented, such as shown below:

$$\frac{m}{z} = \frac{k}{{ω}^{2}} + \frac{{k}_{2}}{{ω}^{4}} + \frac{{k}_{3}}{{ω}^{6}} + …$$

In any case, these calibration coefficients are usually determined by fitting observed frequency data (e.g., observed values of @) and known mass-to-charge ratio data (e.g., known m/z values) from spectra associated with a calibrant (e.g., associated with a known or standardized calibration sample). To locate or identify the chemical species of the calibrant (e.g., to assign an observed peak's frequency value to the correct known m/z value), the following fact can be leveraged: the ratios of frequencies of known calibrant chemical species are constant regardless of calibration coefficients. In other words, the frequency ratio of two known calibrant peaks will always (at least in the first approximation) be the inverse ratio of the square roots of their respective known m/z values. For example, consider a peak A and a peak B of a calibrant. The above first-order formula yields

$${( m / z )}_{A} = \frac{k}{{ω}_{A}^{2}} and {( m / z )}_{B} = \frac{k}{{ω}_{B}^{2}} .$$

By reworking these equations, the following ratios can be obtained:

$$\frac{{ω}_{A}}{{ω}_{B}} = \sqrt{\frac{{( m / z )}_{B}}{{( m / z )}_{A}}}$$

Using this relationship, theoretical or known m/z ratios

$$( e . g . , \frac{{( m / z )}_{B}}{{( m / z )}_{A}} )$$

of pairs of peaks of a given calibrant can be used to compute theoretical frequency ratios

$$( e . g . , \frac{{ω}_{A}}{{ω}_{B}} )$$

for those pairs of peaks of the given calibrant, and such theoretical frequency ratios can be matched to experimentally measured frequency ratios of pairs of peaks indicated in a frequency spectrum produced by an orbital trapping mass analyzer. This matching can allow the experimentally measured frequencies of individual peaks of the given calibrant to be identified, which can then allow frequency-to-mass mapping coefficients (e.g., k) to be identified for the orbital trapping mass analyzer.

Whenever time, phase, and frequency-to-mass mapping coefficients are calibrated for a mass analyzer, such calibrated values are valid only for whatever operational parameter configuration (e.g., whatever specific electrode voltage values or ion trapping or injection durations) that was used by the mass analyzer during such calibration. So, whenever the mass analyzer's operational parameters are switched to new settings, new calibrated values of time, phase, and frequency-to-mass mapping coefficients can be warranted.

Unfortunately, existing techniques facilitate such calibration in an excessively time-consuming fashion. Indeed, when given an operational parameter configuration of a mass analyzer, existing techniques calibrate the time, phase, and frequency-to-mass coefficients of the mass analyzer by causing the mass analyzer to perform multitudes (e.g., hundreds) of scans using that given operational parameter configuration. Such multitudes of scans can require on the order of several minutes to be fully or totally completed. In other words, whenever the operational parameters of the mass analyzer are changed or adjusted, existing techniques require several minutes for the time, phase, and frequency-to-mass coefficients of the mass analyzer to be calibrated. This can be considered as extremely inconvenient for situations in which multiple or repetitive changes or adjustments to the operational parameters are implemented in quick succession, such as during operational parameter tuning procedures (e.g., in which large numbers of operational parameter configurations are sequentially tested to find a configuration that optimizes mass analyzer performance).

Accordingly, systems or techniques that can reduce the time-consumption of mass analyzer calibration for initial time, initial phase, and frequency-to-mass mapping coefficients can be desirable.

Various embodiments described herein can address this technical problem. One or more embodiments described herein can include systems, computer-implemented methods, apparatus, or computer program products that can facilitate rapid mass analyzer calibration via initial time and phase prediction. In particular, the inventor of various embodiments described herein recognized that existing techniques for calibrating initial time, initial phase, and frequency-to-mass mapping coefficients require the performance of so many scans in order to compute so-called “eFT dispersion data.” In various cases, eFT dispersion data can be considered as describing or indicating the shape of second-order dependencies of ion phase with respect to mass-to-charge ratio. The present inventor realized that the shape of such second-order dependencies does not change significantly with operational parameter configuration. Stated differently, the present inventor realized that changes to operational parameters of a mass analyzer cause such second-order dependencies to be translated or shifted with at most negligible change in shape, where the extent or direction of such translation or shifting is represented or dictated by initial time and initial phase. Accordingly, the present inventor realized that, once the shape of such second-order dependencies is known for a given mass analyzer, there can be no need to constantly recompute their shape after each change in operational parameters of the given mass analyzer. Instead, only the initial time and initial phase can require re-computation after each change in operational parameters. Because of this realization, the vast majority of scans (e.g., all but one, for each analytical mass range that is desired to be implemented) that are required by existing techniques can actually be omitted without loss of calibration accuracy. Indeed, the present inventor verified this through their own extensive experimentation (e.g., verified that the initial time and initial phase estimated from a single scan yielded, when used in conjunction with previously-obtained eFT dispersion data, equivalent mass analyzer performance as compared to existing techniques which use many scans to recompute eFT dispersion data along with initial time and initial phase). Moreover, through such extensive experimentation, the present inventor further realized that initial time and initial phase change in a predictable (e.g., in some cases, nearly linear) manner with operational parameter configuration. Accordingly, the present inventor devised various embodiments described herein which can involve predicting (e.g., via machine learning or some other fitted model) initial time and initial phase for any given operational parameter configuration, rather than having to compute the initial time and initial phase from a dedicated scan.

Therefore, various embodiments described herein can be considered as providing a two-pronged speed-up of mass analyzer calibration as compared to existing techniques. A first speed-up can be obtained by omitting, each time that an operational parameter of a mass analyzer is changed, duplicative scans whose purpose is to re-compute eFT dispersion data. A second speed-up can be obtained by predicting or inferring initial time and initial phase of the mass analyzer for any given operational parameter configuration, rather than calculating initial time and initial phase from a dedicated scan performed using that given operational parameter configuration. As experimentally verified by the present inventor, various embodiments described herein can accomplish calibration of initial time, initial phase, and frequency-to-mass mapping coefficients in mere seconds (or, indeed, mere fractions of a second), as compared to the several minutes necessitated by existing techniques.

Various embodiments described herein can be considered as a computerized tool (e.g., any suitable combination of computer-executable hardware or computer-executable software) that can facilitate rapid mass analyzer calibration via initial time and phase prediction. In various aspects, such computerized tool can comprise an access component, a calibration component, or an execution component.

In various embodiments, there can be a mass spectrometer, which may or may not be operatively coupled in any suitable fashion to a chromatograph. In various aspects, the mass spectrometer can comprise any suitable constituent hardware (e.g., any suitable ion beam emitter; any suitable ion detector; any suitable ion optics equipment). In various instances, such constituent hardware can include a mass analyzer whose ion detection is achieved via Fourier transformation (e.g., electrostatic orbital trapping (e.g., ORBITRAP™) mass analyzer, Fourier transform ion cyclotron resonance (FT-ICR) mass analyzer, FT-ion trap mass analyzer with image current detection, RF FT-ion trap mass analyzer with image current detection, a Cassinian trap mass analyzer, a linear trap mass analyzer, a reflectron trap mass analyzer).

In various cases, the mass analyzer can have any suitable types of configurable operational parameters. In various aspects, a configurable operational parameter can be any suitable selectively-controllable hardware characteristic or selectively-controllable software characteristic of the mass analyzer that can be directly adjusted or changed in response to electronic instructions or commands received from a user. For example, such configurable operational parameters can include electrode voltages of the mass analyzer (e.g., voltages of end-cap electrodes, of ring electrodes, of plate electrodes, or of rod electrodes) or timing controls of the mass analyzer (e.g., an ion injection duration or an ion trapping duration).

In any case, it can be desired to calibrate an initial time, an initial phase, and a frequency-to-mass coefficient of the mass analyzer. In various instances, the computerized tool described herein can accomplish such calibration.

In various embodiments, the access component of the computerized tool can electronically access the mass spectrometer. That is, the access component can electronically interface with the mass spectrometer, such that any other components of the computerized tool can electronically interact with (e.g., send electronic commands to, read electronic signals from) the mass spectrometer and thus the mass analyzer.

In various embodiments, the calibration component of the computerized tool can electronically compute a determined initial time, a determined initial phase, and a determined frequency-to-mass coefficient for the mass analyzer, by leveraging at least one fitted model.

In various aspects, the at least one fitted model can be configured to output initial times and initial phases in response to inputted operational parameter configurations.

As a non-limiting example, the at least one fitted model can include an initial time prediction function and an initial phase prediction function. In various instances, the initial time prediction function can be any suitable mathematical function that can take as an input argument an operational parameter configuration of the mass analyzer and that can produce as output an initial time (e.g., a time of ejection/excitation) that such inputted operational parameter configuration would cause the mass analyzer to have or exhibit. In various cases, the initial time prediction function can be defined by a set of first coefficients whose mathematical application (e.g., addition, subtraction, multiplication, division) to the inputted operational parameter configuration yields the outputted initial time. Similarly, in various aspects, the initial phase prediction function can be any suitable mathematical function that can take as an input argument an operational parameter configuration of the mass analyzer and that can produce as output an initial phase (e.g., an ion phase exhibited at the time of ejection/excitation) that such inputted operational parameter configuration would cause the mass analyzer to have or exhibit. Just as above, the initial phase prediction function can be defined by a set of second coefficients whose mathematical application to the inputted operational parameter configuration yields the outputted initial phase. Note that the specific initial time and initial phase that are respectively produced by the initial time prediction function and the initial phase prediction function can depend upon what values are chosen, selected, or used for the set of first coefficients and for the set of second coefficients. In various cases, the calibration component can electronically determine or compute those specific values by causing the mass analyzer to perform a plurality of scans.

In particular, the calibration component can select or choose a plurality of operational parameter configurations of the mass analyzer. In various instances, each of the plurality of operational parameter configurations can be considered as a distinct or unique collection, set, or group of specific values which can be taken on by the operational parameters of the mass analyzer. In other words, the plurality of operational parameter configurations can be considered as discretely spanning the continuous domain or space of values that can possibly be assigned to the operational parameters of the mass analyzer (e.g., as discretely spanning the continuous domain or space of voltage values or timing control values that can be implemented by the mass analyzer). In some cases, each of the plurality of operational parameter configurations can strategically represent or be located at either an extremity or a midpoint within the operational parameter space of the mass analyzer (e.g., one operational parameter configuration can have a push-voltage that is set to a minimum possible value; another operational parameter configuration can have a push-voltage that is set to a maximum possible value; yet another operational parameter configuration can have a push-voltage that is set to a central value that is halfway between those minimum and maximum possible values). Selecting the plurality of operational parameter configurations in such way can cause the plurality of operational parameter configurations to span the operational parameter space with minimum or reduced cardinality.

In any case, the calibration component can generate a respective initial time and a respective initial phase for each of the plurality of operational parameter configurations, based on causing the mass analyzer to perform a respective scan at each of the plurality of operational parameter configurations. For instance, consider any given one of the plurality of operational parameter configurations. In various aspects, the calibration component can instruct or command the mass spectrometer to perform a scan (e.g., on any suitable specimen or sample) using the given operational parameter configuration. In other words, the calibration component can cause the operational parameters (e.g., the electrode voltages, the timing controls) of the mass analyzer to take on or otherwise be set to whatever particular values are specified in the given operational parameter configuration. With the operational parameters being set to the particular values specified in the given operational parameter configuration, the calibration component can then cause the mass spectrometer to perform a scan. Note that such scan can consume very little time (e.g., on the order of mere milliseconds). Such scan can (e.g., prior to post-processing) yield a reference time-domain signal. In various aspects, the reference time-domain signal can be considered as a graph, plot, or chart of relative ion abundance or intensity recorded by the mass spectrometer during the scan as a function of time. In other words, the reference time-domain signal can be considered as a collection of time-intensity tuples, each of which can indicate a unique time during which the mass spectrometer was recording data and a respective intensity value that the mass spectrometer recorded at that time. In various aspects, the calibration component can apply a Fourier transform to the reference time-domain signal, thereby converting the reference time-domain signal into a complex-valued frequency-domain spectrum. Each complex peak in such frequency-domain spectrum can be considered as being located at a respective frequency and as exhibiting a respective phase (e.g., respective angle between their imaginary and real components). In various instances, the calibration component can use those frequencies and phases to construct a respective sinusoid for each peak in the frequency-domain spectrum, where those sinusoids treat time as their independent variable. In various cases, the calibration component can identify at which instant in time a collective phase shift between all those sinusoids is minimized. Such instant in time (which invariably occurs earlier than the very first or initial time at which the mass analyzer detected ions) can be considered as the initial time of the given operational parameter configuration, and whatever collective phase shift is exhibited by those sinusoids at that instant in time can be considered as the initial phase of the given operational parameter configuration.

Now, in various instances, the calibration component can generate one or more parameter-vs-initial-time plots, based on the plurality of operational parameter configurations and the initial times respectively corresponding to the plurality of operational parameter configurations. Indeed, in some cases, each of the parameter-vs-initial-time plots can be considered as a two-dimensional chart whose abscissa represents one of the operational parameters of the mass analyzer and whose ordinate represents initial time. In various aspects, the calibration component can compute, calculate, or otherwise derive specific values for the set of first coefficients that define the initial time prediction function, by leveraging the one or more parameter-vs-initial-time plots. For instance, the specific values of the set of first coefficients can be equal to or otherwise based on respective slopes that are exhibited by the one or more parameter-vs-initial-time plots.

In like fashion, the calibration component can generate one or more parameter-vs-initial-phase plots, based on the plurality of operational parameter configurations and the initial phases respectively corresponding to the plurality of operational parameter configurations. Indeed, in some aspects, each of the parameter-vs-initial-phase plots can be considered as a two-dimensional chart whose abscissa represents one of the operational parameters of the mass analyzer and whose ordinate represents initial phase. In various instances, the calibration component can compute, calculate, or otherwise derive specific values for the set of second coefficients that define the initial phase prediction function, by leveraging the one or more parameter-vs-initial-phase plots. For instance, the specific values of the set of second coefficients can be equal to or otherwise based on respective slopes that are exhibited by the one or more parameter-vs-initial-phase plots.

In this way, the calibration component can generate or create the initial time prediction function and the initial phase prediction function, and those two functions can collectively be considered as forming the at least one fitted model.

As another non-limiting example, the at least one fitted model can instead include a time/phase prediction machine learning model. In various aspects, the time/phase prediction machine learning model can exhibit any suitable artificial intelligence internal architecture. For instance, the time/phase prediction machine learning model can exhibit any suitable type of deep learning neural network internal architecture. For example, the time/phase prediction machine learning model can include any suitable numbers of any suitable types of layers (e.g., input layer, one or more hidden layers, output layer, any of which can be convolutional layers, dense layers, long short-term memory (LSTM) layers, transformer layers, non-linearity layers, pooling layers, batch normalization layers, or padding layers). As another example, the time/phase prediction machine learning model can include any suitable numbers of neurons in various layers (e.g., different layers can have the same or different numbers of neurons as each other). As yet another example, the time/phase prediction machine learning model can include any suitable activation functions (e.g., softmax, sigmoid, hyperbolic tangent, rectified linear unit) in various neurons (e.g., different neurons can have the same or different activation functions as each other). As still another example, the time/phase prediction machine learning model can include any suitable interneuron connections or interlayer connections (e.g., forward connections, skip connections, recurrent connections). However, in other cases, the time/phase prediction machine learning model can exhibit any other suitable type of internal architecture (e.g., support vector machine architecture, random forest regressor architecture, naïve Bayes architecture).

Regardless of its specific internal architecture, the time/phase prediction machine learning model can be considered as a type of regressor that can map, link, or otherwise correlate: values of the configurable operating parameters of the mass analyzer; to initial times and initial phases of the mass analyzer (e.g., of transient signals detected by the mass analyzer). That is, the time/phase prediction machine learning model can be configured to receive as input any given operational parameter configuration and to compute as output the initial time and initial phase which that inputted operational parameter configuration would cause the mass analyzer to have. In order accomplish this, the calibration component can utilize the above-mentioned plurality of operational parameter configurations and their respective initial times and initial phases as annotated training data. In other words, the calibration component can train the time/phase prediction machine learning model in supervised fashion, by treating each of the plurality of operational parameter configurations as a training input, and by treating whatever initial time and initial phase correspond to that operational parameter configuration as a ground-truth annotation. It should be understood or otherwise appreciated that the time/phase prediction machine learning model can be configured to receive any suitable auxiliary inputs in addition to operational parameter configurations (e.g., in some cases, the time/phase prediction machine learning model can be configured to receive as input not just an operational parameter configuration but also whatever reference time-domain signal was produced or generated by the mass analyzer using that operational parameter configuration).

In this way, the calibration component can generate or create the time/phase prediction machine learning model, and such model itself can be considered as the at least one fitted model.

No matter the particular form or construction of the at least one fitted model, the calibration component can generate the at least one fitted model by causing the mass analyzer to perform a respective scan at each of the plurality of operational parameter configurations. Each of such scans can consume mere milliseconds (e.g., about 38 milliseconds in some situations). Additionally, when the plurality of operational parameter configurations are selected or chosen strategically (e.g., such that each configuration represents a unique extremity or midpoint within the operational parameter space of the mass analyzer), the cardinality of the plurality of operational parameter configurations can be kept minimal or otherwise small (e.g., indeed, experiments conducted by the present inventor demonstrated high calibration accuracy using as few as 16 configurations in the plurality of operational parameter configurations). Thus, it can require as little one second or less (e.g., merely half a second, in some cases) in order to generate the at least one fitted model.

In various aspects, the calibration component can compute the determined initial time and the determined initial phase, by executing the at least one fitted model on any user-selected operational parameter configuration of the mass analyzer. In various instances, the user-selected operational parameter configuration can be considered as being whatever specific values that are which a user has assigned to the operational parameters of the mass analyzer. Indeed, after the at least one fitted model is generated, the user of the mass spectrometer can select or configure the operational parameters of the mass analyzer in any desired fashion (e.g., in preparation for scanning a desired sample), and such configuration can be considered as the user-selected operational parameter configuration. In various cases, the calibration component can feed the current or present-time operational parameter configuration as input to the at least one fitted model, and the at least one fitted model can produce as output the determined initial time and the determined initial phase. Thus, the determined initial time and the determined initial phase can be considered as being whatever initial time and initial phase that the user-selected operational parameter configuration is predicted or inferred to cause the mass analyzer to have or exhibit.

Now, in various aspects, the calibration component can cause the mass analyzer to perform a single scan on any suitable calibrant using the user-selected operational parameter configuration and using the determined initial time and determined initial phase. More specifically, an autosampler (e.g., syringe pump, or any other type of sample injection/infusion device) associated with the mass spectrometer can have at least one cartridge or chamber that is filled with the calibrant, which can be any suitable standardized sample or specimen having a known mass spectrum. In various instances, with the operational parameters of the mass analyzer being set to the particular values specified in the user-selected operational parameter configuration, the calibration component can cause the mass spectrometer to inject a portion of the calibrant and perform a scan on that injected portion. Note that such scan can consume very little time (e.g., on the order of mere milliseconds). Such scan can yield a time-domain signal, and the calibration component can convert that time-domain signal into a frequency-domain spectrum by applying an eFT operation using the determined initial time and the determined initial phase (e.g., indeed, eFT can be considered as an established mathematical algorithm or procedure that takes as input arguments a time-domain signal, an initial time, and an initial phase and that produces as output a frequency-domain spectrum). In various aspects, the frequency-domain spectrum can be considered as a graph, plot, or chart of relative ion abundance or intensity recorded by the mass spectrometer during the scan as a function of frequency. In other words, the frequency-domain spectrum can be considered as a collection of frequency-intensity tuples, each of which can indicate a unique frequency detected by the mass spectrometer during its scan and a respective intensity value that the mass spectrometer recorded at that frequency. In various aspects, the frequency-domain spectrum can have any suitable number of peaks (e.g., of local maxima), each of which can correspond to (e.g., can be centered about) a respective frequency value. In various instances, because of the above-mentioned relationship between frequency ratios and m/z-ratios, the calibration component can calculate or compute the determined frequency-to-mass coefficient, by matching measured frequency ratios of pairs of peaks in the frequency-domain spectrum to theoretical frequency ratios derived from m/z-ratios of pairs of peaks indicated in the known mass spectrum of the calibrant. After all, the known mass spectrum can exhibit its own peaks at respective m/z values. So, for each given pair of peaks (e.g., peak A and peak B) in the frequency-domain spectrum, the calibration component can identify which corresponding pair of peaks in the mass spectrum has a theoretical frequency ratio

$$( e . g . , \frac{{ω}_{A}}{{ω}_{B}} = \sqrt{\frac{{( m / z )}_{B}}{{( m / z )}_{A}}} )$$

that matches the measured or actual frequency ratio of that given pair of peaks. By performing such matching for multiple (e.g., more than two) pairs of peaks, the determined frequency-to-mass coefficient (e.g., k) can be computed with high accuracy.

In various embodiments, the execution component of the computerized tool can electronically leverage the determined initial time, the determined initial phase, and the determined frequency-to-mass coefficient to reliably or accurately generate mass spectra for any desired samples. More specifically, whatever autosampler is associated with the mass spectrometer can have at least one cartridge or chamber that is filled with a desired sample (e.g., in some cases, the desired sample can be the given calibrant mentioned above; in other cases, the desired sample can instead be any suitable unknown or non-standardized sample or specimen for which mass spectra are desired to be generated). In various instances, with the operational parameters of the mass analyzer being set to the particular values specified in the user-selected operational parameter configuration, the execution component can cause the mass spectrometer to inject a portion of the desired sample and perform a scan on that injected portion. Note that such scan can consume very little time (e.g., on the order of mere milliseconds) and can yield a time-domain signal. In various cases, the execution component can convert that time-domain signal into a frequency-domain spectrum by applying an eFT operation using the determined initial time and the determined initial phase. Furthermore, in various aspects, the execution component can convert that frequency-domain spectrum into a mass spectrum by applying the determined frequency-to-mass coefficient.

Now, in some embodiments, the user of the mass spectrometer can set the operational parameters of the mass analyzer to new values after generation of the mass spectrum for the desired sample (e.g., the user may be performing a tuning procedure to see which operational parameter configuration optimizes mass analyzer performance). In response to the mass analyzer having a new user-selected operational parameter configuration, the calibration component can generate a new determined initial time and a new determined initial phase by executing the at least one fitted model on that new user-selected operational parameter configuration. Note that, since the at least one fitted model has already been generated, the new determined initial time and new determined initial phase can be computed without forcing the mass analyzer to perform any additional respective scans at the plurality of operational parameter configurations. Next, the calibration component can cause the mass analyzer to perform a single scan on any suitable calibrant using the new user-selected operational parameter configuration, thereby yielding a new time-domain signal. The calibration component can perform an eFT operation on that new time-domain signal using the new determined initial time and the new determined initial phase, thereby yielding a new frequency-domain spectrum. In various aspects, the calibration component can then match frequency ratios exhibited by pairs of peaks in that new frequency-domain spectrum to m/z ratios exhibited by pairs of peaks in whatever known mass spectrum corresponds to the calibrant, thereby yielding a new determined frequency-to-mass coefficient. At such point, the execution component can cause the mass analyzer to perform a scan on any suitable desired sample using the new user-selected operational parameter configuration, the new determined initial time, the new determined initial phase, and the new determined frequency-to-mass coefficient, thereby yielding a new mass spectrum for that desired sample.

Note how much time can be saved by various embodiments described herein as compared to existing techniques, particularly in situations requiring repeated changes to the operational parameters of the mass analyzer (e.g., such as mass analyzer tuning procedures). Indeed, suppose that it is desired to perform multiple sequential scans on a particular sample, each of those multiple scans having a different or unique operational parameter configuration of the mass analyzer. Existing techniques would require several minutes of calibration to be consumed prior to each of those multiple scans (e.g., before each desired scan, existing techniques would require the mass analyzer to perform a plethora of calibration scans in order to identify an appropriate initial time, an appropriate initial phase, and an appropriate frequency-to-mass coefficient). In stark contrast, various embodiments described herein would instead consume about one second or so for generation of the at least one fitted model, and would thereafter consume mere milliseconds of calibration prior to each of those multiple scans (e.g., before each desired scan, various embodiments described herein would require the mass analyzer to perform only a single calibration scan in order to identify an appropriate frequency-to-mass coefficient; no additional scans are needed for identification of an appropriate initial time and an appropriate initial phase, since those can be nearly instantaneously predicted by the at least one fitted model). Stated differently, existing techniques require the expenditure of several minutes of calibration whenever an operational parameter change affects the mass analyzer. In contrast, various embodiments described herein instead require an up-front expenditure of about one second to generate the at least one fitted model regardless of how many operational parameter changes affect the mass analyzer, and then require the expenditure mere milliseconds of calibration (e.g., the time it takes to perform a single calibrant scan to identify frequency-to-mass coefficients) whenever an operational parameter change affects the mass analyzer.

Various embodiments described herein can be employed to use hardware or software to solve problems that are highly technical in nature (e.g., to facilitate rapid mass analyzer calibration via initial time and phase prediction), that are not abstract and that cannot be performed as a set of mental acts by a human. Further, some of the processes performed can be performed by a specialized computer (e.g., mass spectrometers coupled to liquid, gas, or ion chromatographs) for carrying out defined acts related to the field of mass analyzer calibration.

For example, such defined acts can include: accessing, by a device operatively coupled to a processor, a mass analyzer; and calibrating, by the device, the mass analyzer, based on predicting an initial time and an initial phase of the mass analyzer via at least one fitted model. In various aspects, the device can predict the initial time and the initial phase based on feeding a current operational parameter configuration of the mass analyzer as input to the at least one fitted model. In various instances, such defined acts can include causing, by the device, the mass analyzer to perform a plurality of scans at a respectively corresponding plurality of operational parameter configurations, thereby yielding a plurality of reference time-domain signals; and computing, by the device and via application of a Fourier transform and sinusoid construction to the plurality of reference time-domain signals, a respective initial time and a respective initial phase for each of the plurality of operational parameter configurations. In some cases, such defined acts can include generating, by the device, a plurality of parameter-vs-initial-time plots and a plurality of parameter-vs-initial-phase plots, based on the respective initial time and respective initial phase for each of the plurality of operational parameter configurations; and generating, by the device, the at least one fitted model using coefficients that are derived from the plurality of parameter-vs-initial-time plots and the plurality of parameter-vs-initial-phase plots. Indeed, the plurality of operational parameter configurations can be extremities or midpoints within an operational parameter space of the mass analyzer, and the coefficients can be slopes exhibited by the plurality of parameter-vs-initial-time plots and the plurality of parameter-vs-initial-phase plots. In other cases, the at least one fitted model can exhibit an artificial intelligence architecture, and such defined acts can include training, by the device, the at least one fitted model, using the respective initial time and respective initial phase for each of the plurality of operational parameter configurations as annotated training data. In various aspects, such defined acts can include causing, by the device, the mass analyzer to perform a calibrant scan using the initial time and initial phase predicted by the at least one fitted model and using frequency-ratio and mass-ratio matching, thereby yielding a frequency-to-mass coefficient.

Such defined acts are inherently computerized. Indeed, a mass spectrometer is a highly-technical computerized device comprising specific computerized hardware (e.g., temperature sensors, pressure sensors, voltage sensors, ion beam emitters, electron beam emitters, focusing lenses, ion detectors, electron detectors, beam apertures, fluid valves). A mass spectrometer, the operations that it performs, and the time-domain, frequency-domain, or mass-domain spectra that it captures cannot be implemented by the human mind, or by a human with mere pen and paper, in any reasonable or practicable way without computers. Furthermore, a mass analyzer is a specific, tangible constituent piece of hardware in various scientific instruments that separates, arranges, orders, measures, or otherwise distinguishes ions according to mass-to-charge ratio. A mass analyzer and the ion-distinguishing functionality that it performs cannot be implemented in any way whatsoever by the human mind or by a human with mere pen and paper.

Moreover, various embodiments described herein can integrate into a practical application various teachings relating to the field of mass analyzer calibration. As explained above, the transient data generated by some mass analyzers, such as orbital trapping mass analyzers, can be post-processed in accordance with an eFT signal processing protocol. In order for an eFT signal processing protocol to be properly or reliably performed, two quantities are required: an initial time value (e.g., time at which ions are ejected from an ion trap toward the mass analyzer); and an initial phase value (e.g., phase of the ions at the initial time value). Although a third quantity—a frequency-to-mass coefficient—can be technically not required for performance of eFT signal processing, such third quantity can nevertheless be considered as required for mass analyzer calibration (e.g., to allow the frequency-domain results yielded by eFT signal processing to be converted into an m/z-domain). These three quantities change depending upon the operational parameter configuration of the mass analyzer. Thus, whenever the operational parameters of the mass analyzer are set to new values, these three quantities should be calibrated anew. Existing techniques involve estimating these three quantities by causing the mass analyzer to perform a multitude of scans (e.g., dozens or hundreds of scans), which can consume a total of several minutes to complete. In situations where frequent or numerous changes to the operational parameters of the mass analyzer are desired or expected (e.g., such as during a mass analyzer tuning procedure), the consumption of several minutes of calibration after each operational parameter change can be considered as highly sluggish and inconvenient.

Various embodiments described herein can help to ameliorate this technical problem. In particular, various embodiments described herein can facilitate rapid, quick, non-sluggish, or otherwise non-inconvenient calibration of the three above-mentioned quantities, by leveraging initial time and initial phase prediction. More specifically, the present inventor recognized that existing techniques require so many calibration scans in order to calculate or compute so-called eFT dispersion data, which can be considered as describing the shape of second-order dependencies of phase with respect to m/z. The present inventor realized that, contrary to the teachings of existing techniques, such eFT dispersion data does not appreciably change with operational parameter configuration. The present inventor thus conducted various experiments in which the three above-mentioned quantities were calibrated using a single scan rather than a multitude of scans (e.g., in situations where multiple analytical mass ranges are desired to be implemented, this meant using a single scan per analytical mass range rather than a multitude of scans per analytical mass range). During such experiments, the present inventor realized that the calibrated values of initial time and initial phase appeared to follow a predictable pattern. Using this insight garnered from her own thorough experimentation, the present inventor devised various embodiments described herein, which can involve predicting or forecasting initial time and initial phase for any new operational parameter configuration, rather than actually measuring initial time and initial phase for that new operational parameter configuration via scanning. Although some scans can be required up-front in order to generate the fitted model, such scans can be strategically performed (e.g., using operational parameter configurations that represent endpoints or midpoints in the operational parameter space of the mass analyzer), such that their total cardinality is kept low (e.g., to 16 or fewer). Ultimately, this can mean that a mere second or so is consumed up-front to generate the fitted model, and that the fitted model can subsequently be executed with nearly negligible time-consumption so as to predict calibrated values of initial time and initial phase for any new operational parameter configuration of the mass analyzer. A single scan can still be required in order to determine the frequency-to-mass coefficient for each new operational parameter configuration, but such single scan can consume mere milliseconds. Thus, various embodiments described herein can involve calibrating the three above-mentioned quantities via the consumption of about one or second or so up-front and thereafter of mere milliseconds per each new operational parameter configuration that is encountered. Contrast this with existing techniques that instead require the consumption of several minutes (e.g., due to the performance of dozens or hundreds of scans) for each new operational parameter configuration that is encountered.

Furthermore, it must be emphasized how counterintuitive various embodiments described herein are. Indeed, prior to the teachings described herein, existing techniques taught that eFT dispersion data should always be re-computed for each new operational parameter configuration, so as to achieve maximum or optimal mass analyzer performance. However, the present inventor, through her extensive research, realized that eFT dispersion data does not appreciably change as operational parameter values change. Accordingly, the present inventor realized that the voluminous scans which existing techniques treated as invaluable and necessary for the calibration of the three above-mentioned quantities were, in actuality, not invaluable or necessary at all. Indeed, the present inventor realized that the three above-mentioned quantities could be accurately calibrated using just two scans (e.g., one to calibrate initial time and initial phase, and another to calibrate frequency-to-mass coefficient) for any given operational parameter configuration. In other words, the present inventor realized that all the extra scans which existing techniques performed to recompute eFT dispersion data could be eschewed or eliminated. While verifying the efficacy of such few-scan calibrations, the present inventor noticed that initial time and initial phase appeared to exhibit predictable patterns in response to operational parameter changes. Thus, the present inventor devised various embodiments described herein, which can involve predicting calibrated values of initial time and initial phase, rather than directly measuring such calibrated values from actual scans. Accordingly, the chain of research and experimentation leading to various embodiments described herein was sparked by the present inventor's counter-intuitive and surprising realization that eFT dispersion data changes at most negligibly with operational parameter configuration and that the multitude of calibration scans whose purpose is to recompute eFT dispersion data can thus be omitted. Such realization is diametrically opposed to the central principles of existing teachings which treated the re-computation of eFT dispersion data as paramount. In other words, a person having ordinary skill in the art would never have realized that eFT dispersion data need not be re-computed and would thus never have embarked on the experimental journey that led to various embodiments described herein. Because of this, various embodiments described herein can be considered as being highly creative, unusual, or otherwise unexpected in view of existing techniques.

For at least the above reasons, various embodiments described herein can be considered as addressing or ameliorating various technical problems or disadvantages that plague existing techniques. Therefore, various embodiments described herein can be considered as a concrete and tangible technical improvement or technical effect in the field of mass analyzer calibration. Accordingly, various embodiments described herein certainly qualify as useful and practical applications of computers.

Furthermore, various embodiments described herein can control real-world tangible devices based on the disclosed teachings. For example, various embodiments described herein can electronically activate, deactivate, or otherwise actuate real-world hardware (e.g., electrodes) of real-world mass analyzers.

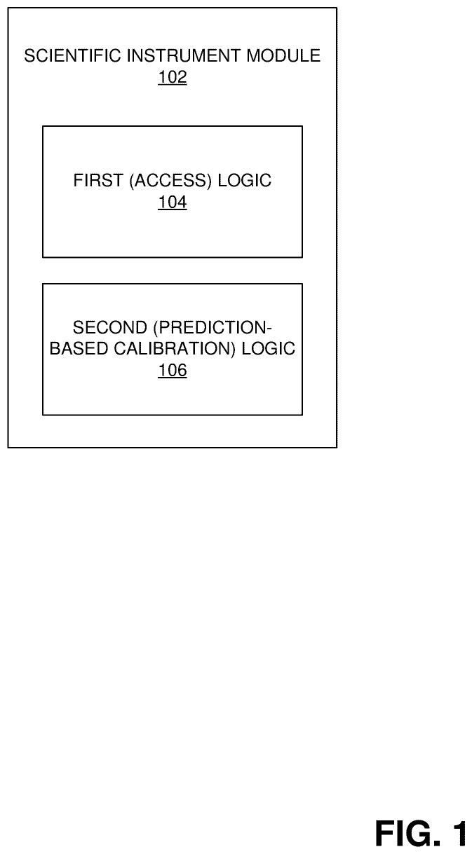

FIG. 1 illustrates an example, non-limiting block diagram of a scientific instrument module 102 in accordance with various embodiments described herein.

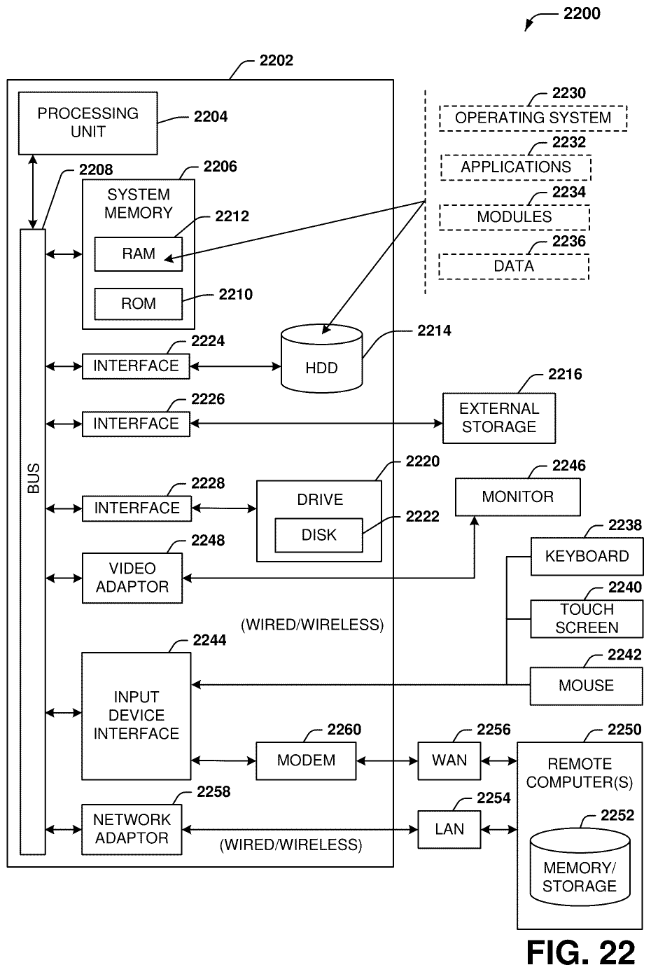

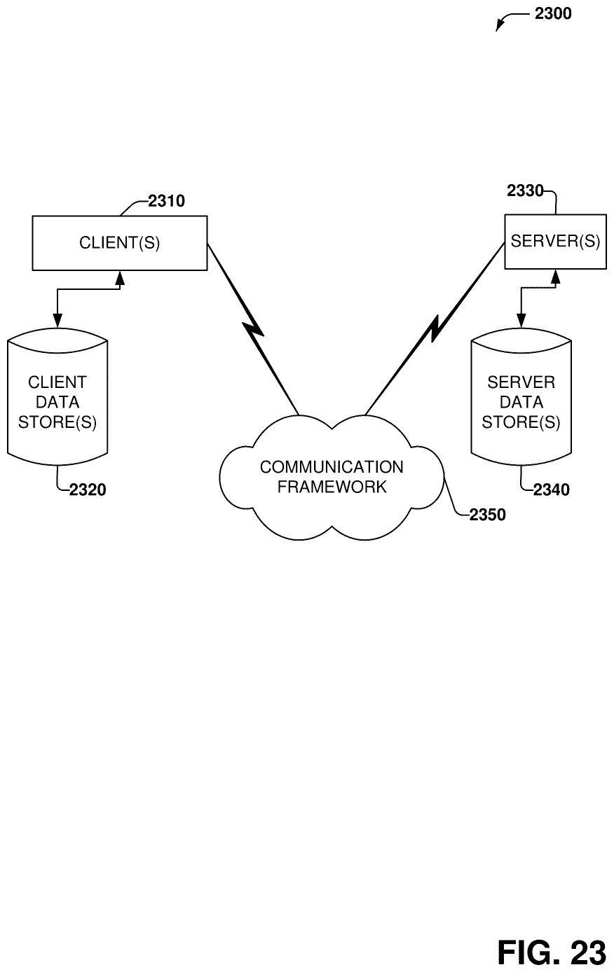

In various embodiments, the scientific instrument module 102 can be implemented by circuitry (e.g., including electrical or optical components), such as a programmed computing device. Logic of the scientific instrument module 102 can be included in a single computing device or can be distributed across multiple computing devices that are in communication with each other as appropriate. Examples of computing devices that may, singly or in combination, implement the scientific instrument module 102 are discussed herein with reference to FIG. 22, and examples of systems or networks of interconnected computing devices, in which the scientific instrument module 102 may be implemented across one or more of the computing devices, are discussed herein with reference to FIG. 23.

The scientific instrument module 102 can include first logic 104 and second logic 106. As used herein, the term “logic” can include an apparatus that is to perform a set of operations associated with the logic. For example, any of the logic elements included in the scientific instrument module 102 can be implemented by one or more computing devices programmed with instructions to cause one or more processing devices of the computing devices to perform the associated set of operations. In a particular embodiment, a logic element may include one or more non-transitory computer-readable media having instructions thereon that, when executed by one or more processing devices of one or more computing devices, cause the one or more computing devices to perform the associated set of operations. As used herein, the term “module” can refer to a collection of one or more logic elements that, together, perform a function associated with the module. Different ones of the logic elements in a module may take the same form or may take different forms. For example, some logic in a module may be implemented by a programmed general-purpose processing device, while other logic in a module may be implemented by an application-specific integrated circuit (ASIC). In another example, different ones of the logic elements in a module may be associated with different sets of instructions executed by one or more processing devices. A module can omit one or more of the logic elements depicted in the associated drawings; for example, a module may include a subset of the logic elements depicted in the associated drawings when that module is to perform a subset of the operations discussed herein with reference to that module.

In various embodiments, there can be a scientific instrument corresponding to the scientific instrument module 102. In various aspects, the scientific instrument can be any suitable computerized device that can electronically measure some scientifically-relevant, clinically-relevant, or research-relevant characteristic, property, or attribute of an analytical specimen (e.g., of a known or unknown mixture, compound, or collection of matter). As a non-limiting example, a scientific instrument can be a scanning electron microscope. In such case, the scientific instrument can measure or determine a surface topography of the analytical specimen. As another non-limiting example, a scientific instrument can be a transmission electron microscope. In such case, the scientific instrument can measure or determine internal structural details of the analytical specimen. As yet another non-limiting example, a scientific instrument can be an electron energy-loss microscope. In such case, the scientific instrument can measure or determine location-wise counts or intensities across a range of defined energy-loss bins or bands for the analytical specimen. As a more general non-limiting example, a scientific instrument can be any suitable type of charged-particle microscope (e.g., some types of microscopes can use beams of non-electron ions to capture images or energy spectra or to otherwise interact with specimens). As another non-limiting example, a scientific instrument can be a mass spectrometer that is operatively coupled to a chromatograph. In such case, the scientific instrument can measure or determine chromatograms (e.g., relative compound abundance as a function of retention time) or ion spectra (e.g., relative ion abundance as a function of mass-to-charge ratio) of the analytical sample. In any of such situations, the scientific instrument can include or otherwise contain a mass analyzer.

In various embodiments, the first logic 104 can involve accessing or otherwise establishing electronic communication with the mass analyzer.

In various embodiments, the second logic 106 can involve calibrating the mass analyzer based on predicting an initial time and initial phase of the mass analyzer via at least one fitted model. More specifically, the second logic 106 can involve causing the mass analyzer to perform a set of scans, each at a respective operational parameter configuration. In various aspects, this can yield a set of time-domain signals produced by the mass analyzer. In various instances, the second logic 106 can involve deriving (e.g., via Fourier transformation and sinusoid construction) a respective initial time and initial phase from each those time-domain signals. In various cases, the fitted model can be any suitable mathematical function or composition thereof that can be fitted to such operational parameter configurations, initial times, and initial phases (e.g., operational parameter configuration can be considered as an independent variable of the fitted model; initial time and initial phase can be considered as dependent variables of the fitted model; and whatever coefficients define or make up the fitted model can be derived from the results of the mass analyzer scans). In any case, the fitted model can be able to predict or infer what initial time and initial phase a given or inputted operational parameter configuration will cause the mass analyzer to have. Thus, whenever the mass analyzer is set to a new or uncalibrated operational parameter configuration by a user, the fitted model can be leveraged so as to calibrate the initial time and the initial phase of the mass analyzer in a non-time-consuming fashion. This can be considered as especially useful in situations where numerous or repetitive adjustments to the operational parameters of the mass analyzer are expected (e.g., such as during mass analyzer parameter tuning procedures).

Accordingly, the scientific instrument module 102 can facilitate rapid mass analyzer calibration via initial time and phase prediction.

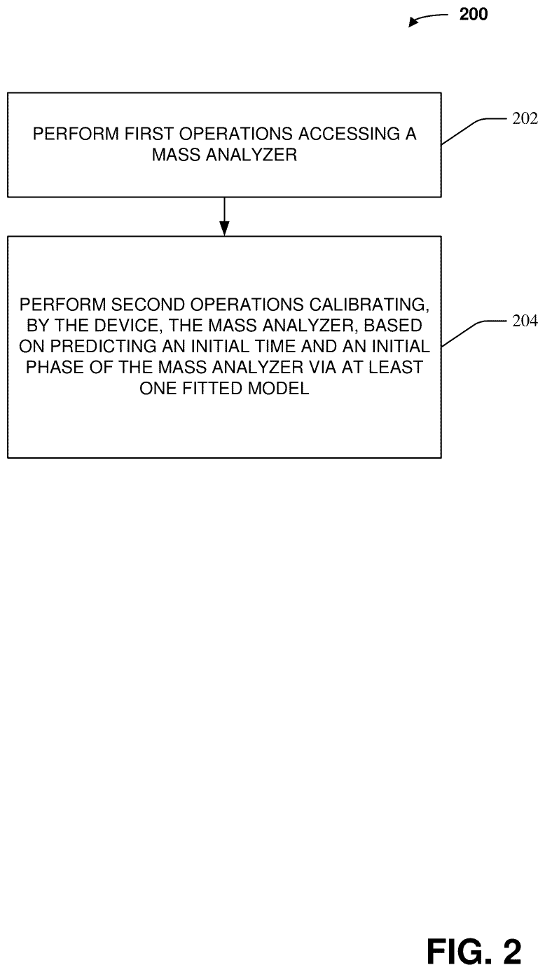

FIG. 2 is an example, non-limiting flow diagram of a computer-implemented method 200 in accordance with various embodiments described herein. The operations of the computer-implemented method 200 may be used in any suitable context to perform any suitable operations (e.g., can be performed by or used in conjunction with any of the various modules, computing devices, or graphical user interfaces described with respect to of FIGS. 1, 22, and 23). Operations are illustrated once each and in a particular order in FIG. 2, but the operations may be reordered or repeated as desired and appropriate (e.g., different operations performed may be performed in parallel, as suitable).

In various aspects, act 202 can include performing first operations accessing a mass analyzer. In various cases, the first logic 104 can perform or otherwise facilitate act 202.

In various aspects, act 204 can include performing second operations calibrating the mass analyzer based on predicting an initial time and an initial phase of the mass analyzer via at least one fitted model. In various instances, the second logic 106 can perform or otherwise facilitate act 204.

Accordingly, the computer-implemented method 200 can facilitate rapid mass analyzer calibration via initial time and phase prediction.

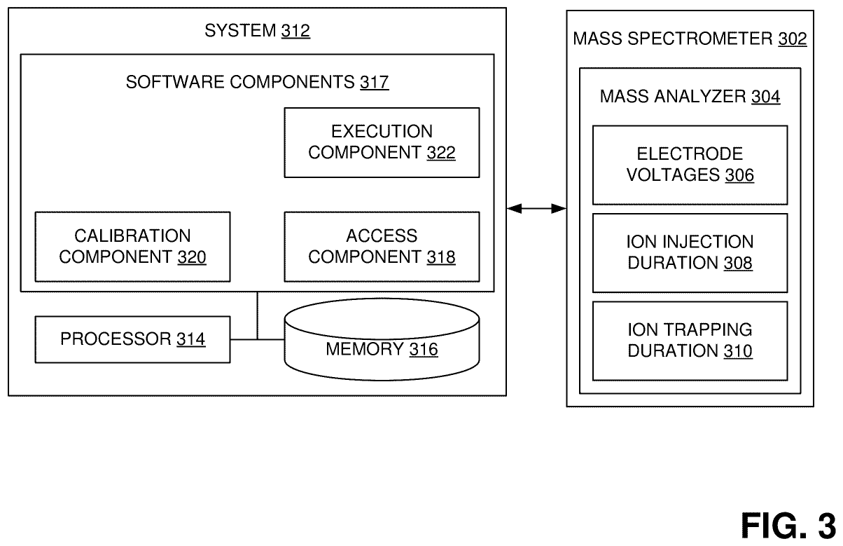

FIG. 3 illustrates a block diagram of an example, non-limiting system that can facilitate rapid mass analyzer calibration via initial time and phase prediction in accordance with one or more embodiments described herein.

In various embodiments, there can be a mass spectrometer 302. In various aspects, the mass spectrometer 302 can be any suitable type of mass spectrometer exhibiting any suitable design or construction for measuring ion spectra of analytical samples. In various instances, the mass spectrometer 302 can be made up of any suitable constituent hardware. As a non-limiting example, the mass spectrometer 302 can include any suitable ion source or ion beam emitter, such as a matrix assisted laser desorption/ionization (MALDI) source, electrospray ionization (ESI) source, atmospheric pressure chemical ionization (APCI) source, atmospheric pressure photoionization (APPI) source, or inductively coupled plasma (ICP) source. As another non-limiting example, the mass spectrometer 302 can include any suitable ion detectors, such as electron multiplier detectors, microchannel plate detectors, image charge detectors, or Faraday cup detectors. As even another non-limiting example, the mass spectrometer 302 can include any suitable ion optics equipment, such as ion focusing lenses, ion guides, or ion deflectors. In some instances, the mass spectrometer 302 can be any suitable type of Fourier transform mass spectrometer.

In various cases, one of the pieces of constituent hardware that make up the mass spectrometer 302 can be a mass analyzer 304. In various aspects, the mass analyzer 304 can exhibit any suitable design or construction that can physically separate (or, in some instances, otherwise distinguish without physically separating) ions according to their mass-to-charge ratios in accordance with Fourier transform signal processing. As a non-limiting example, the mass analyzer 304 can be any suitable type of orbital trapping mass analyzer. As another non-limiting example, the mass analyzer 304 can be any suitable type of Fourier transform ion cyclotron resonance mass analyzer.

No matter its particular design or construction, the mass analyzer 304 can be considered as having any suitable number of any suitable types of configurable operational parameters. In various aspects, a configurable operational parameter can be any suitable hardware-related characteristic or software-related characteristic of the mass analyzer 304 that can guide, affect, or otherwise dictate how the mass analyzer 304 physically separates or otherwise distinguishes ions according to mass-to-charge ratio and that can be selectively controlled, changed, adjusted, or otherwise set (e.g., by a user of the mass spectrometer 302 or automatically).

In some cases, such configurable operational parameters can include one or more electrode voltages 306 of the mass analyzer 304. Indeed, the mass analyzer 304 can have or be made up of one or more electrodes. As a non-limiting example, a quadrupole mass analyzer can have four rod electrodes arranged in parallel pairs which, when driven by applied voltages, create an electric field that filters passing ions according to mass-to-charge ratio. As another non-limiting example, a quadrupole ion trap or linear ion trap mass analyzer can have an ion trap that is sandwiched between various endcap electrodes or ring electrodes, and driving such electrodes with applied voltages can create an oscillating electric field that can trap and selectively eject ions from a three-dimensional or one-dimensional trapping region based on mass-to-charge ratio. As yet another non-limiting example, a time-of-flight mass analyzer can have repeller electrodes that divert ions from an ion source toward a flight tube, accelerator electrodes that speed up the ions in the flight tube, and drift electrodes that help steer the paths of the ions within the flight tube, where the amount of time it takes for a given ion to traverse the flight tube indicates mass-to-charge ratio. As still another non-limiting example, an orbital trapping mass analyzer can have a spindle electrode surrounded by split outer electrodes, such that driving those electrodes via applied voltages causes ions to orbit the spindle electrode, and such that the orbital characteristics (e.g., period) of a given ion indicates its mass-to-charge ratio. In any case, the mass analyzer 304 can have one or more electrodes, and the configurable, controllable, or selectable voltages of those one or more electrodes can be referred to as the one or more electrode voltages 306. In various instances, each of the one or more electrode voltages 306 can be a scalar measured in any suitable units of voltage (e.g., volts, kilovolts, millivolts).

In some cases, the configurable operational parameters of the mass analyzer 304 can include an ion injection duration 308. In various aspects, the ion injection duration 308 can be a configurable, controllable, or selectable amount of time during which the mass analyzer 304 permits ions emitted from an ion source of the mass spectrometer 302 to enter the mass analyzer 304. The longer the ion injection duration 308 is, the more ions that are permitted to enter the mass analyzer 304 during any suitable scan, which can help to increase signal-to-noise ratios of any resulting mass spectra. In various instances, the ion injection duration 308 can be a scalar measured in any suitable units of time (e.g., seconds, milliseconds, microseconds).

In some cases, the configurable operational parameters of the mass analyzer 304 can include an ion trapping duration 310. In various aspects, the ion trapping duration 310 can be a configurable, controllable, or selectable amount of time during which the mass analyzer 304 traps or confines ions to any suitable defined subregion of the mass analyzer 304 (e.g., trapped in a volume bounded by endcap and ring electrodes; trapped in a volume surrounding a spindle electrode and bounded by split outer electrodes). In some cases, the longer the ion trapping duration 310 is, the higher the sensitivity of the mass analyzer 304, but the greater the likelihood of resolution reduction or inter-ion reactions. But in other cases (e.g., for orbital trapping mass analyzers), the longer the ion trapping duration 310, the higher the resolution (assuming adequately low pressure). In various instances, the ion trapping duration 310 can be a scalar measured in any suitable units of time (e.g., seconds, milliseconds, microseconds).

It should be understood or otherwise appreciated that the mass analyzer 304 can have any other suitable types of configurable operational parameters. The one or more electrode voltages 306, the ion injection duration 308, and the ion trapping duration 310 are mere non-limiting examples. For instance, any other suitable type of timing control can be considered as a configurable operational parameter of the mass analyzer 304, such as a time between ion ejections, such as respective ramping times for the one or more electrode voltages 306, or such as timing of ion ejection relative to voltage ramping (sometimes referred to as Waves-to-Eject). It should also be understood or otherwise appreciated that, in various embodiments, the mass analyzer 304 can have fewer configurable operational parameters than those shown in the figures. For instance, the configurable operational parameters can, in some cases, exclude or omit the ion injection duration 308 or the ion trapping duration 310 (after all, electrode voltages can be considered as having a much stronger impact or influence of initial time and initial phase than ion injection or trapping duration).

Depending upon its specific design or construction, the mass analyzer 304 can be considered as having, being equipped with, or otherwise being associated with any suitable type of ion trap from which the mass analyzer 304 can physically receive trapped ions. As a non-limiting example, the mass analyzer 304 can have, be physically equipped or outfitted with, be physically integrated with, or be physically downstream of a quadrupole ion trap. As another non-limiting example, the mass analyzer 304 can have, be physically equipped or outfitted with, be physically integrated with, or be physically downstream of a linear ion trap. As yet another non-limiting example, the mass analyzer 304 can have, be physically equipped or outfitted with, be physically integrated with, or be physically downstream of a curved ion trap (e.g., C-Trap). As still another non-limiting example, the mass analyzer 304 can have, be physically equipped or outfitted with, be physically integrated with, or be physically downstream of a SLIM (structures for lossless ion manipulations) device or any suitable ion trap array.

In any case, it can be desired to apply eFT signal processing to data captured by the mass analyzer 304. In particular, the mass analyzer 304 can generate or capture time-domain signals, and such time-domain signals can be converted into frequency-domain spectra, and subsequently into mass spectra, via eFT operations or processing protocols. In order for such eFT operations or processing protocols to be properly, accurately, or reliably performed, whatever phase is exhibited by the ions that are stored or accumulated in the ion trap at the temporal or chronological instant when ejection (and thus excitation) of such ions into the mass analyzer 304 is commenced must be determined. Such temporal or chronological instant can be referred to as an initial time of the mass analyzer 304, and the phase at such instant can be referred to as an initial phase of the mass analyzer 304. In various aspects, a system 312 can facilitate determination of the initial time and initial phase of the mass analyzer 304 as described herein.

Note that the system 312 can, in some cases, be implemented on or hosted by the mass spectrometer 302 itself or any suitable computerized workstation that is associated with or coupled to the mass spectrometer 302. In such situations, the system 312 can be considered as being deployed in a client-side fashion (e.g., the system 312 can be considered as being local to the mass spectrometer 302). However, in other cases, the system 312 can instead be implemented or hosted remotely from the mass spectrometer 302, such as in a cloud computing environment. In such situations, the system 312 can be considered as being deployed in a server-side fashion.

In various aspects, the system 312 can comprise a processor 314 (e.g., computer processing unit, microprocessor) and a non-transitory computer-readable memory 316 that is operably or operatively or communicatively connected or coupled to the processor 314. The non-transitory computer-readable memory 316 can store computer-executable instructions which, upon execution by the processor 314, can cause the processor 314 or other components of the system 312 (e.g., access component 318, calibration component 320, execution component 322) to perform one or more acts. In various embodiments, the non-transitory computer-readable memory 316 can store computer-executable components (e.g., access component 318, calibration component 320, execution component 322), and the processor 314 can execute the computer-executable components.

In various embodiments, the system 312 can include an access component 318. In various aspects, the access component 318 can electronically access the mass spectrometer 302 and thus the mass analyzer 304. That is, the access component 318 can electronically communicate or otherwise electronically interact with (e.g., transmit electronic instructions or commands to; receive electronic data from) the mass spectrometer 302 in any suitable fashion. Accordingly, the access component 318 can act as a proxy or conduit through which any other components of the system 312 can interact with, communicate with, activate, deactivate, or otherwise manipulate the mass spectrometer 302 or the mass analyzer 304.

In various embodiments, the system 312 can include a calibration component 320. In various aspects, the calibration component 320 can, as described herein, compute a determined initial time and a determined initial phase for the mass analyzer 304, by leveraging a fitted model that is configured to predict initial time and initial phase for inputted operational parameter configurations.

In various embodiments, the system 312 can include an execution component 322. In various instances, the execution component 322 can, as described herein, cause the mass analyzer 304 to scan any suitable sample using the determined initial time and the determined initial phase predicted by the fitted model.

Note that, in various instances, the access component 318, the calibration component 320, and the execution component 322 can collectively be considered as being one or more software components 317 of the system 312. In various aspects, it should be appreciated that the one or more software components 317 are described primarily herein as comprising three components (e.g., the access component 318, the calibration component 320, and the execution component 322) for ease of explanation and illustration. However, the one or more software components 317 are not limited to being implemented as exactly such three components in every embodiment. Indeed, in some embodiments, the functionalities described herein of such three components can be combined in any suitable fashions, so as to be implemented in or by fewer than three components (e.g., in some cases, a single component can perform all of the functionalities that are described herein with respect to the access component 318, the calibration component 320, and the execution component 322). In other embodiments, the functionalities described herein of such three components can instead be distributed, separated, split, or fragmented in any suitable fashions, so as to be implemented in or by more than three components (e.g., two or more components can facilitate the functionalities that are performable by the access component 318; two or more components can facilitate the functionalities that are performable by the calibration component 320; two or more components can facilitate the functionalities that are performable by the execution component 322).

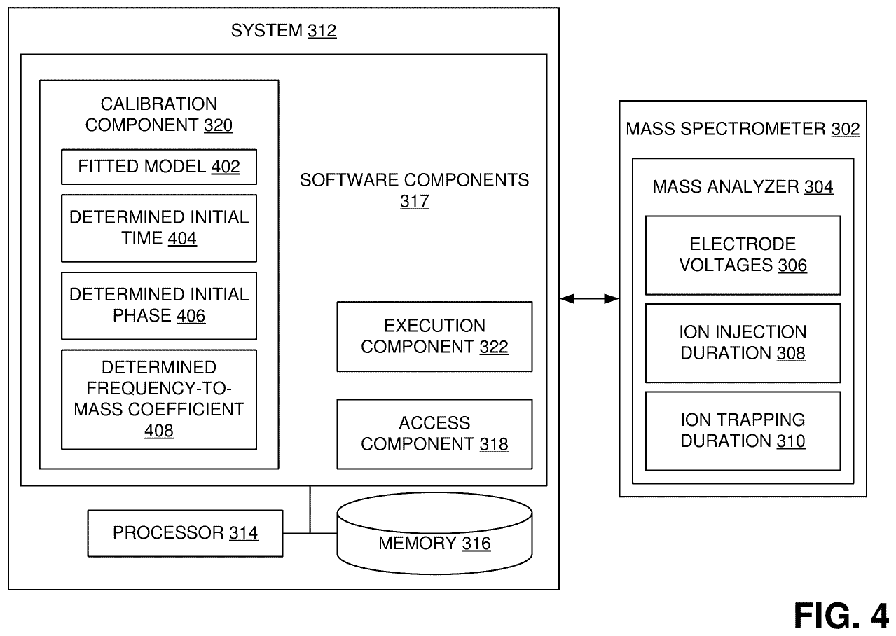

FIG. 4 illustrates a block diagram of an example, non-limiting system including at least one fitted model, a determined initial time, a determined initial phase, and a determined frequency-to-mass coefficient that can facilitate rapid mass analyzer calibration via initial time and phase prediction in accordance with one or more embodiments described herein.

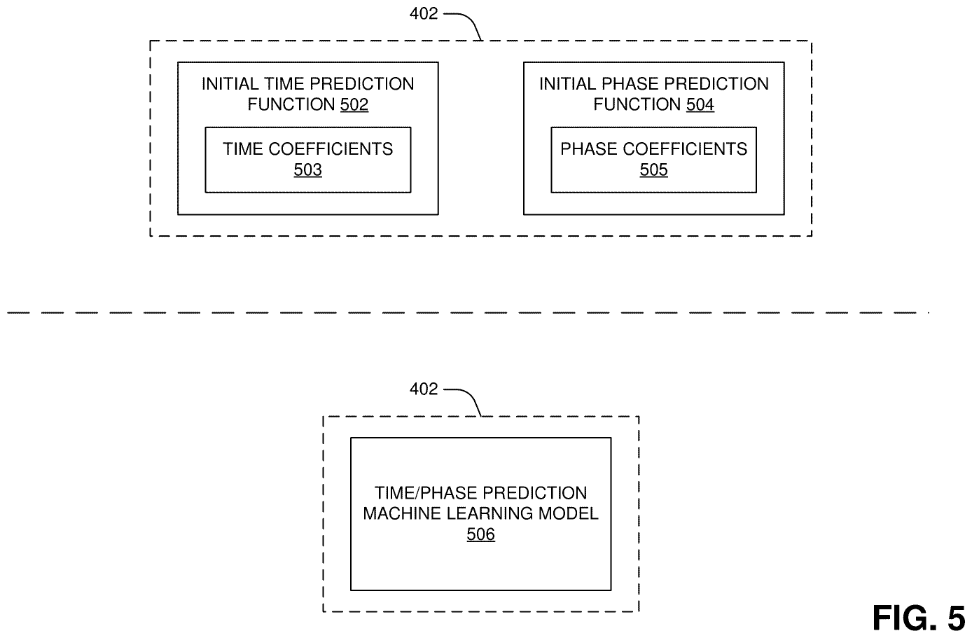

In various embodiments, the calibration component 320 can electronically store, electronically maintain, electronically control, or otherwise electronically access at least one fitted model 402. In various aspects, the calibration component 320 can electronically leverage the at least one fitted model 402, so as to calculate, compute, or otherwise determine a determined initial time 404, a determined initial phase 406, and a determined frequency-to-mass coefficient 408 for the mass analyzer 304. Non-limiting aspects are described with respect to FIGS. 5-14.

FIGS. 5-14 illustrate example, non-limiting block diagrams showing how the at least one fitted model 402 can be leveraged to generate the determined initial time 404, the determined initial phase 406, and the determined frequency-to-mass coefficient 408 in accordance with one or more embodiments described herein.

First, consider FIG. 5, which illustrates various embodiments of the at least one fitted model 402.

In some embodiments, the at least one fitted model 402 can include or otherwise be made up of an initial time prediction function 502 and an initial phase prediction function 504.

In various aspects, the initial time prediction function 502 can be any suitable mathematical function or composition of mathematical functions that are intended to model, forecast, or otherwise predict what initial time the mass analyzer 304 will have or exhibit, when given an operational parameter configuration of the mass analyzer 304. In other words, the initial time prediction function 502 can be any suitable combination of mathematical operators (e.g., addition operators, subtraction operators, multiplication operators, division operators, root operators, power operators, exponential operators, logarithmic operators, trigonometric operators, rounding operators, derivative operators, integral operators) which can convert an input argument into an output argument. In various instances, the input argument of the initial time prediction function 502 can be a real-valued vector representing respective values of the operational parameters of the mass analyzer 304. In various cases, the output argument of the initial time prediction function 502 can be a real-valued scalar representing an initial time of the mass analyzer 304. That is, the initial time prediction function 502 can mathematically transform or convert an inputted operational parameter configuration into an outputted initial time, and such transformation or conversion can be interpreted to mean that performing scans using the inputted operational parameter configuration will cause the mass analyzer 304 to exhibit the outputted initial time.

Regardless of the specific structure or format of the initial time prediction function 502, it can be made up of or otherwise defined by a set of time coefficients 503. In various instances, the set of time coefficients 503 can include any suitable number of coefficients, each of which can be considered as a real-valued scalar variable. In various cases, the initial time prediction function 502 can be considered as computing the outputted initial time by mathematically combining in any suitable fashion the inputted operational parameter configuration with the set of time coefficients 503. As a non-limiting example, any of the set of time coefficients 503 can be considered as a constant that is added to, subtracted from, multiplied by, or divided by any value indicated or specified in the inputted operational parameter configuration. As another non-limiting example, any of the set of time coefficients 503 can be considered as a power or root to which any value indicated or specified in the inputted operational parameter configuration is raised. As even another non-limiting example, any of the set of time coefficients 503 can be considered as a base whose exponent is some function of any value indicated or specified in the inputted operational parameter configuration.

Likewise, the initial phase prediction function 504 can be any suitable mathematical function or composition of mathematical functions that are intended to model, forecast, or otherwise predict what initial phase the mass analyzer 304 will have or exhibit, when given an operational parameter configuration of the mass analyzer 304. That is, the initial phase prediction function 504 can be any suitable combination of mathematical operators which can convert an input argument into an output argument. In various aspects, the input argument of the initial phase prediction function 504 can be a real-valued vector representing respective values of the operational parameters of the mass analyzer 304, and the output argument of the initial phase prediction function 504 can be a real-valued scalar representing an initial phase of the mass analyzer 304. So, the initial phase prediction function 504 can mathematically transform or convert an inputted operational parameter configuration into an outputted initial phase, and such transformation or conversion can be interpreted to mean that performing scans using the inputted operational parameter configuration will cause the mass analyzer 304 to exhibit the outputted initial phase.

Just as above, regardless of the specific structure or format of the initial phase prediction function 504, it can be made up of or otherwise defined by a set of phase coefficients 505. In various instances, the set of phase coefficients 505 can include any suitable number of coefficients, each of which can be considered as a real-valued scalar variable. As above, the initial phase prediction function 504 can be considered as computing the outputted initial phase by mathematically combining in any suitable fashion the inputted operational parameter configuration with the set of phase coefficients 505. As a non-limiting example, any of the set of phase coefficients 505 can be considered as a constant that is added to, subtracted from, multiplied by, or divided by any value indicated or specified in the inputted operational parameter configuration. As another non-limiting example, any of the set of phase coefficients 505 can be considered as a power or root to which any value indicated or specified in the inputted operational parameter configuration is raised. As even another non-limiting example, any of the set of phase coefficients 505 can be considered as a base whose exponent is some function of any value indicated or specified in the inputted operational parameter configuration.

In other embodiments, the at least one fitted model 402 can instead include or otherwise be made up of a time/phase prediction machine learning model 506. In various aspects, the time/phase prediction machine learning model 506 can exhibit any suitable type of artificial intelligence internal architecture. As a non-limiting example, the time/phase prediction machine learning model 506 can exhibit any suitable deep learning neural network internal architecture. Indeed, in various cases, the time/phase prediction machine learning model 506 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. As even another example, any of such input layer, one or more hidden layers, or output layer can be LSTM layers, whose learnable or trainable parameters can be input-state weight matrices or hidden-state weight matrices. As yet another example, any of such input layer, one or more hidden layers, or output layer can be transformer layers, whose learnable or trainable parameters can be single-head or multi-head attention blocks or other weight matrices. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers. However, in other non-limiting examples, the time/phase prediction machine learning model 506 can exhibit any suitable non-neural-network internal architecture, such as a decision tree internal architecture, a random forest regressor internal architecture, a naïve Bayes internal architecture, or a logistic regression internal architecture.

Regardless of the specific internal architecture (e.g., the specific numbers, types, or organizations of layers) that is implemented within the time/phase prediction machine learning model 506, the time/phase prediction machine learning model 506 can be configured as a type of regressor that infers initial time and initial phase from inputted operational parameter configurations. In other words, the time/phase prediction machine learning model 506 can be constructed so as to receive as input an operational parameter configuration of the mass analyzer 304 and to infer as output what initial time and initial phase that inputted operational parameter configuration will cause or force the mass analyzer 304 to have.

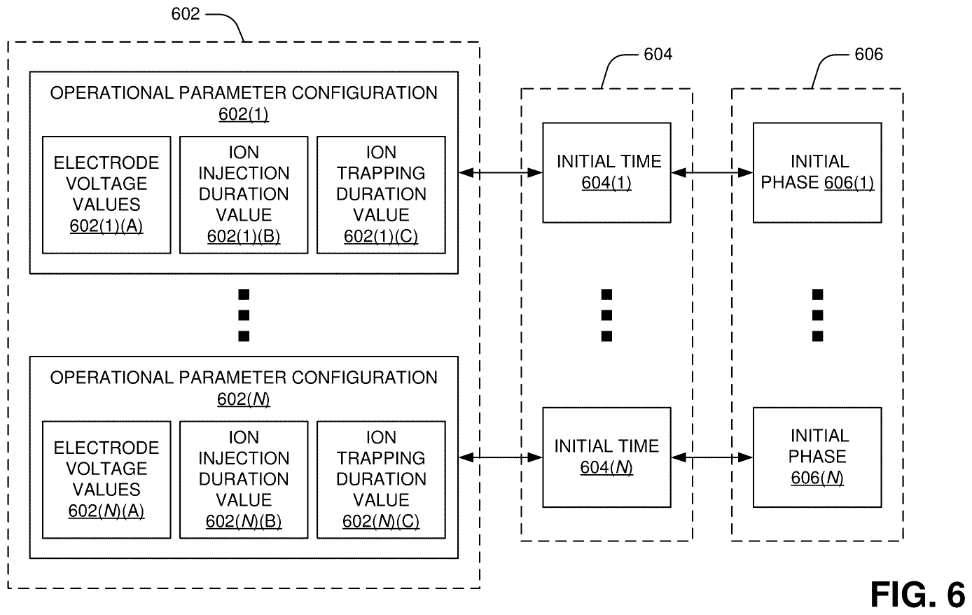

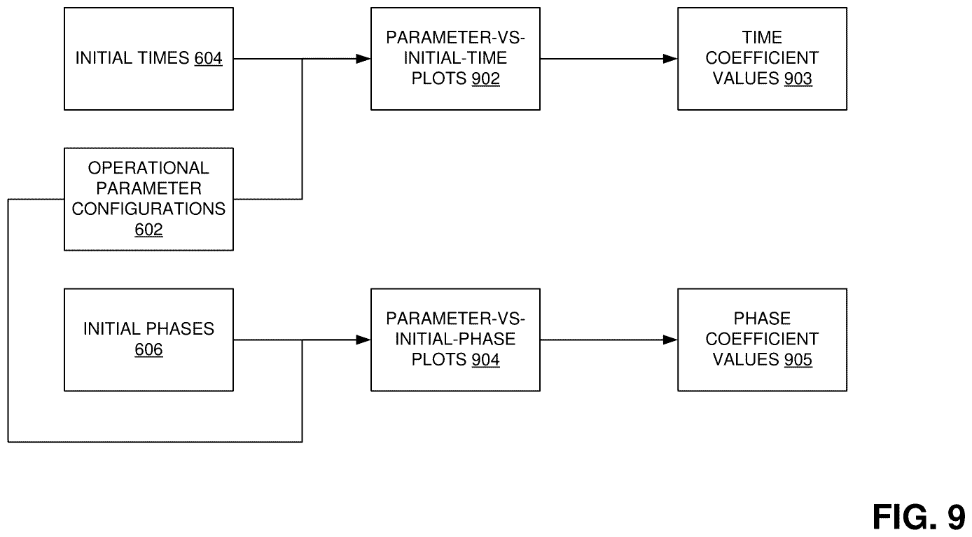

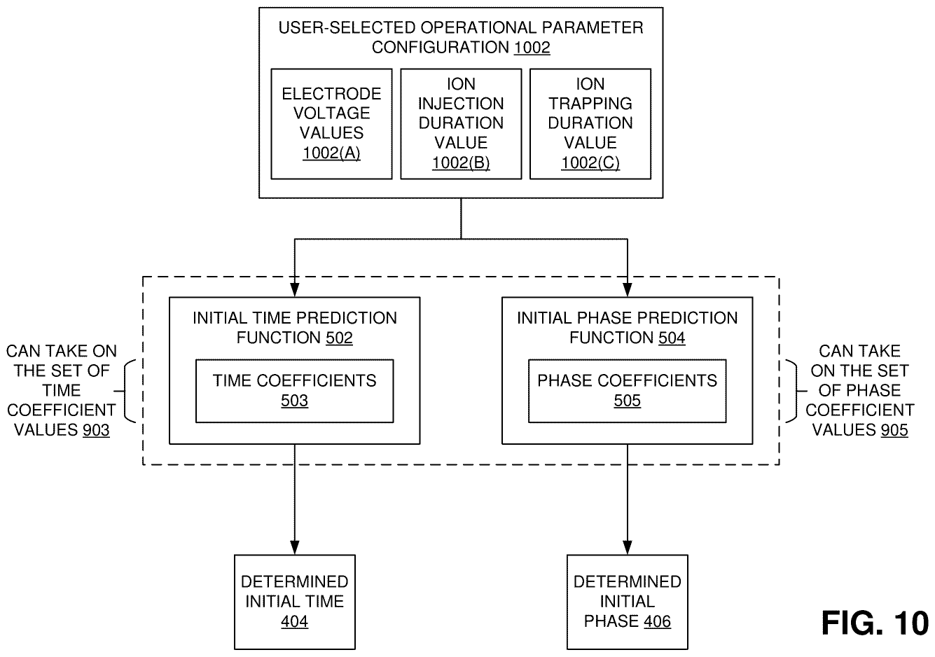

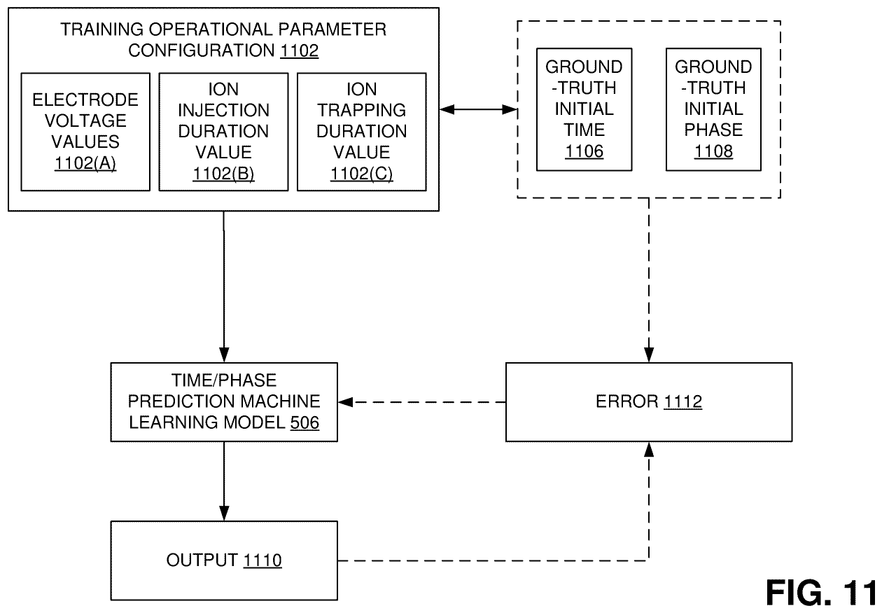

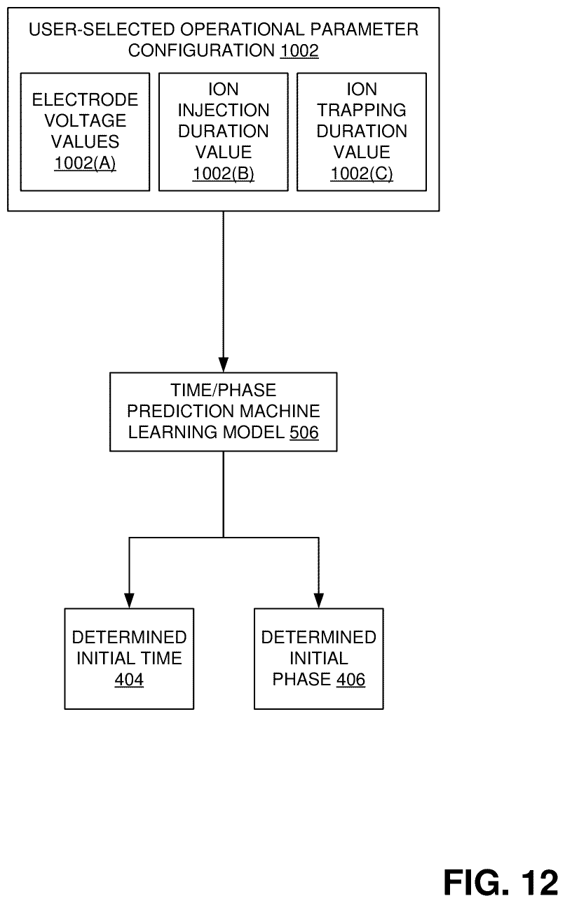

FIGS. 6-8 show non-limiting aspects that are applicable both to situations in which the at least one fitted model 402 includes the initial time prediction function 502 and the initial phase prediction function 504 and to situations in which the at least one fitted model 402 includes the time/phase prediction machine learning model 506. FIGS. 9-10 show non-limiting aspects regarding how the initial time prediction function 502 and the initial phase prediction function 504 can be generated and utilized. In contrast, FIGS. 11-12 show non-limiting aspects regarding how the time/phase prediction machine learning model 506 can be generated and utilized.

First, consider FIG. 6. In various embodiments, there can be a plurality of operational parameter configurations 602. In various aspects, the plurality of operational parameter configurations 602 can include a total of n configurations, for any suitable positive integer n>1: an operational parameter configuration 602(1) to an operational parameter configuration 602(n). In various instances, each of the plurality of operational parameter configurations 602 can be considered as a unique or distinct location within the operational parameter space of the mass analyzer 304. In other words, each of the plurality of operational parameter configurations 602 can be any suitable electronic data having any suitable format, size, or dimensionality (e.g., can be one or more scalars, one or more vectors, one or more matrices, or one or more tensors) that specifies, indicates, or otherwise represents respective values that could possibly be assigned to or otherwise taken on by the operational parameters of the mass analyzer 304.

As a non-limiting example, the operational parameter configuration 602(1) can specify, indicate, or otherwise represent one or more electrode voltage values 602(1)(A), an ion injection duration value 602(1)(B), or an ion trapping duration value 602(1)(C). In various cases, the one or more electrode voltage values 602(1)(A) can be specific or particular amounts or levels of electric voltage potentials to which the one or more electrode voltages 306 could be controllably set. Likewise, the ion injection duration value 602(1)(B) can be a specific or particular length of time to which the ion injection duration 308 could be controllably set. Similarly, the ion trapping duration value 602(1)(C) can be a specific or particular length of time to which the ion trapping duration 310 could be controllably set.

As another non-limiting example, the operational parameter configuration 602(n) can specify, indicate, or otherwise represent one or more electrode voltage values 602(n)(A), an ion injection duration value 602(n)(B), or an ion trapping duration value 602(n)(C). In various cases, the one or more electrode voltage values 602(n)(A) can be specific or particular amounts or levels of electric voltage potentials to which the one or more electrode voltages 306 could be controllably set. Likewise, the ion injection duration value 602(n)(B) can be a specific or particular length of time to which the ion injection duration 308 could be controllably set. Similarly, the ion trapping duration value 602(n)(C) can be a specific or particular length of time to which the ion trapping duration 310 could be controllably set.

To help clarify, suppose that the mass analyzer 304 has a total of s operational parameters, for any suitable positive integer s>2 (e.g., the ion injection duration 308 plus the ion trapping duration 310 plus s−2 electrode voltages). In such case, the operational parameter space of the mass analyzer 304 can be considered as an s-dimensional Euclidean space. In other words, the operational parameter space can be considered as an abstract space formed by s axes that orthogonally intersect at an origin, with each axis running along or otherwise representing the domain of possible values that can be controllably assigned to a respective one of the s operational parameters of the mass analyzer 304. So, any point or location within that operational parameter space can be indicated or represented as an s-element tuple, each numerical element of which can be a specific scalar value that can be controllably assigned to a respective one of the s operational parameters of the mass analyzer 304. Thus, each of the plurality of operational parameter configurations 602 can be considered as a unique s-element tuple within the operational parameter space.

In various aspects, the plurality of operational parameter configurations 602 can be strategically selected or chosen so as to span the operational parameter space with a minimum cardinality (e.g., such that the plurality of operational parameter configurations 602 can discretely represent or capture the breadth of the operational parameter space with n being as small as feasible or practicable).

In some cases, this can be accomplished or achieved if each of the plurality of operational parameter configurations 602 represents an extremity within the operational parameter space. For example, if the mass analyzer 304 has a total of s operational parameters each of which can range from some respective minimum value to some respective maximum value, then n can be equal to (or in some cases lesser than) 25, where each of the plurality of operational parameter configurations 602 can be a unique s-element tuple each numerical element of which can be equal to either the minimum value or the maximum value of whatever operational parameter it represents. For instance, suppose that mass analyzer 304 has two operational parameters: a push voltage that can range from a minimum denoted PVₘᵢₙ to a maximum denoted PVₘₐₓ; and a central electrode voltage that can range from a minimum denoted CEVₘᵢₙ to a maximum denoted CEVₘₐₓ. In such situation, the plurality of operational parameter configurations 602 can have a total of four configurations: a first configuration where the push voltage is set to PVₘᵢₙ and the central electrode voltage is set to CEVₘᵢₙ; a second configuration where the push voltage is set to PVₘₐₓ and the central electrode voltage is set to CEVₘᵢₙ; a third configuration where the push voltage is set to PVₘᵢₙ and the central electrode voltage is set to CEVₘₐₓ; and a fourth configuration where the push voltage is set to PVₘₐₓ and the central electrode voltage is set to CEVₘₐₓ.

In other cases, this can be accomplished or achieved if each of the plurality of operational parameter configurations 602 represents an extremity or a midpoint within the operational parameter space. For example, if the mass analyzer 304 has a total of s operational parameters each of which can range from some respective minimum value to some respective maximum value, then n can be equal to (or in some cases lesser than) 35, where each of the plurality of operational parameter configurations 602 can be a unique s-element tuple each numerical element of which can be equal to the minimum value, the maximum value, or a central/midpoint value of whatever operational parameter it represents. For instance, suppose that mass analyzer 304 has two operational parameters: a push voltage that can range from a minimum denoted PVₘᵢₙ to a maximum denoted PVₘₐₓ with a midpoint denoted PV_{mid}; and a central electrode voltage that can range from a minimum denoted CEVₘᵢₙ to a maximum denoted CEVₘₐₓ with a midpoint denoted CEV_{mid}. In some of such situations, the plurality of operational parameter configurations 602 can have a total of nine configurations: a first configuration where the push voltage is set to PVₘᵢₙ and the central electrode voltage is set to CEVₘᵢₙ; a second configuration where the push voltage is set to PV_{mid} and the central electrode voltage is set to CEVₘᵢₙ; a third configuration where the push voltage is set to PVₘₐₓ and the central electrode voltage is set to CEVₘᵢₙ; a fourth configuration where the push voltage is set to PVₘᵢₙ and the central electrode voltage is set to CEV_{mid}; a fifth configuration where the push voltage is set to PV_{mid} and the central electrode voltage is set to CEV_{mid}; a sixth configuration where the push voltage is set to PVₘₐₓ and the central electrode voltage is set to CEV_{mid}; a seventh configuration where the push voltage is set to PVₘₐₓ and the central electrode voltage is set to CEVₘᵢₙ; an eighth configuration where the push voltage is set to PVₘₐₓ and the central electrode voltage is set to CEV_{mid}; and a ninth configuration where the push voltage is set to PVₘₐₓ and the central electrode voltage is set to CEVₘₐₓ.

In any case, the calibration component 320 can electronically identify a plurality of initial times and a plurality of initial phases that respectively correspond (e.g., in one-to-one fashion) to the plurality of operational parameter configurations 602. In various aspects, the plurality of initial times 604 can include n times: an initial time 604(1) to an initial time 604(n). Likewise, the plurality of initial phases 606 can include n phases: an initial phase 606(1) to an initial phase 606(n). In various instances, each of the plurality of initial times 604 can be considered as the temporal or chronological point of ion trap ejection/excitation for a respective one of the plurality of operational parameter configurations 602. In various cases, each of the plurality of initial phases 606 can be considered as the exhibited ion phase at the temporal or chronological point of ion trap ejection/excitation for a respective one of the plurality of operational parameter configurations 602. As a non-limiting example, the initial time 604(1) and the initial phase 606(1) can correspond to the operational parameter configuration 602(1). Thus, the initial time 604(1) can be a scalar that indicates or represents the instant in time at which squeezed ions are begun to be ejected toward the mass analyzer 304 from the ion trap as a result of the mass analyzer 304 being set to the operational parameter configuration 602(1), and the initial phase 606(1) can be a scalar that indicates or represents what phase those squeezed ions have at that instant in time. As another non-limiting example, the initial time 604(n) and the initial phase 606(n) can correspond to the operational parameter configuration 602(n). So, the initial time 604(n) can be a scalar that indicates or represents the instant in time at which squeezed ions are begun to be ejected toward the mass analyzer 304 from the ion trap as a result of the mass analyzer 304 being set to the operational parameter configuration 602(n), and the initial phase 606(n) can be a scalar that indicates or represents what phase those squeezed ions have at that instant in time.

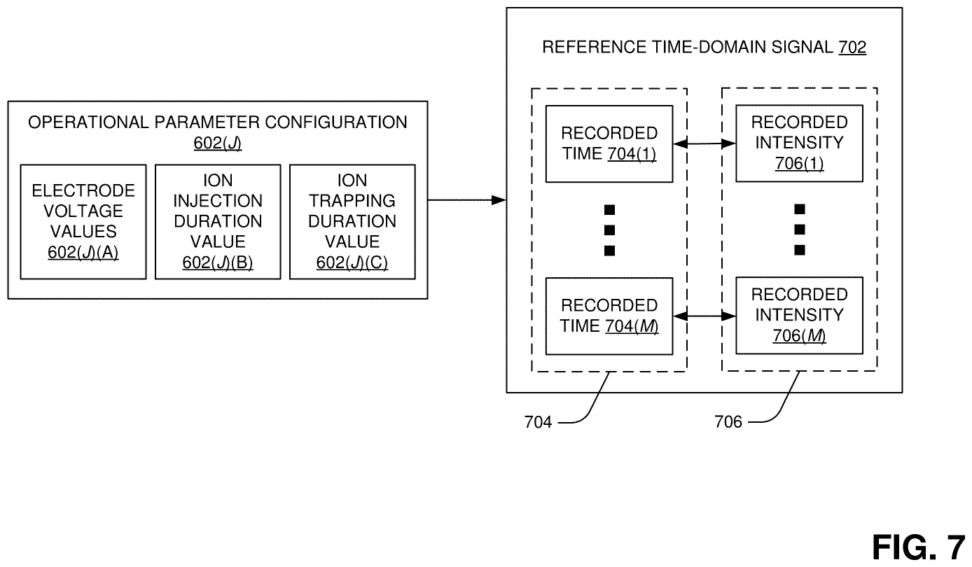

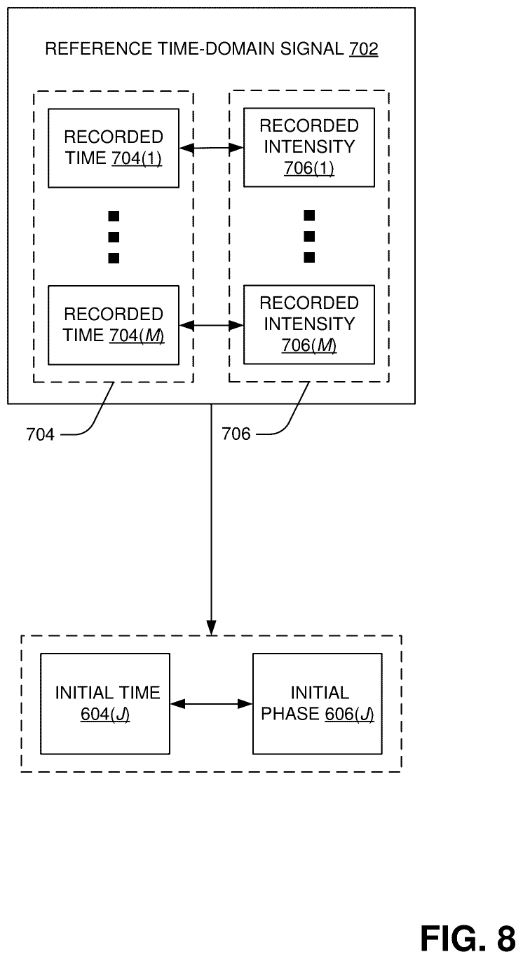

FIGS. 7-8 illustrate non-limiting details regarding how the plurality of initial times 604 and the plurality of initial phases 606 can be obtained.

Consider FIG. 7. In various embodiments, the calibration component 320 can select any one of the plurality of operational parameter configurations 602. Such selected configuration can be referred to as an operational parameter configuration 602(j), for any suitable positive integer j≤n. Note that the operational parameter configuration 602(j) can thus include or specify one or more electrode voltage values 602(j)(A), an ion injection duration value 602(j)(B), and an ion trapping duration value 602(j)(C). In various instances, the calibration component 320 can cause the mass spectrometer 302, and thus the mass analyzer 304, to perform a single scan (e.g., on any suitable sample, or on no sample at all) using the operational parameter configuration 602(j). In other words, the calibration component 320 can electronically instruct, electronically command, or otherwise electronically cause the mass spectrometer 302 to run or activate while the configurable operational parameters of the mass analyzer 304 are set or configured to whatever specific values are specified in the operational parameter configuration 602(j). Such scan can cause the mass spectrometer 302 to record, yield, or otherwise produce a reference time-domain signal 702.

In various aspects, the reference time-domain signal 702 can be a graph, plot, or chart of recorded intensity as a function of time. In other words, the reference time-domain signal 702 can be a collection of tuples, each tuple indicating a unique time and a respective intensity value that was recorded by the mass spectrometer 302 at that unique time. For ease of illustration and explanation, suppose that the reference time-domain signal 702 is made up of m tuples, for any suitable positive integer m>1. In such case, the reference time-domain signal 702 can be considered as including a plurality of recorded times 704 and a plurality of recorded intensities 706, both of which can have a cardinality of m. That is, the plurality of recorded times 704 can have a total of m times: a recorded time 704(1) to a recorded time 704(m). Likewise, the plurality of recorded intensities 706 can have a total of m intensities: a recorded intensity 706(1) to a recorded intensity 706(m). In various aspects, each of the plurality of recorded times 704 can be or represent a unique instant in time that occurred during the scan performed by the mass spectrometer 302 (e.g., a recorded time 704(i+1) can be greater or later than a recorded time 704(j) for all positive integers i<m). In various instances, each of the plurality of recorded intensities 706 can be an ion intensity value, abundance, or count that was recorded by the mass spectrometer 302 at a respective one of the plurality of recorded times 704. As a non-limiting example, the recorded intensity 706(1) can be whatever ion intensity value, abundance value, or count that was detected or measured by the mass spectrometer 302 at whatever instant is represented by the recorded time 704(1). As another non-limiting example, the recorded intensity 706(m) can be whatever ion intensity value, abundance value, or count that was detected or measured by the mass spectrometer 302 at whatever instant is represented by the recorded time 704(m). Note how the recorded time 704(1) and the recorded intensity 706(1) can be considered as collectively forming a first time-intensity tuple of the reference time-domain signal 702. Similarly, note how the recorded time 704(m) and the recorded intensity 706(m) can be considered as collectively forming an m-th time-intensity tuple of the reference time-domain signal 702.

In some instances, the reference time-domain signal 702 can be considered as a measure of the bulk image current induced on outer electrodes of the mass analyzer 304 by ions oscillating en masse versus time. Each of the plurality of recorded times 704 can be or represent a unique instant in time that occurred during the mass analyzer's transient detection period. Each of the plurality of recorded intensity values 706 can be or represent a measure of the induced image current from the bulk of oscillating ions in the mass analyzer 304 at a respective point in time.

Next, consider FIG. 8. In various embodiments, the calibration component 320 can electronically apply any suitable signal processing techniques to the reference time-domain signal 702, so as to compute an initial time 604(j) (which can be considered as whichever one of the plurality of initial times 604 that corresponds to the operational parameter configuration 602(j)) and an initial phase 606(j) (which can be considered as whichever one of the plurality of initial phases 606 that corresponds to the operational parameter configuration 602(j)). As a non-limiting example, the calibration component 320 can apply a Fourier transform to the reference time-domain signal 702, thereby converting it into a reference frequency-domain spectrum (not shown), which can be considered as a collection of frequency-intensity tuples rather than time-intensity tuples. Each peak (e.g., each local maximum) in the reference frequency-domain spectrum can be considered as having a real portion and an imaginary portion. For any given peak in the reference frequency-domain spectrum, a magnitude of that given peak can be equal to a square root of a sum of squares of the real and imaginary portions, and a phase of that given peak can be equal to an arctangent of a ratio formed by dividing the imaginary portion by the real portion. So, the given peak can be considered as having a respective frequency and a respective phase. Thus, the calibration component 320 can construct for that given peak a sinusoid function using that respective frequency and respective phase and whose independent variable is time. In this way, the calibration component 320 can construct a respective sinusoid function for each peak in the reference frequency-domain spectrum, thereby yielding multiple sinusoid functions. Note that each of those multiple sinusoid functions will have a unique frequency of oscillation. Recall that sinusoid functions of different frequencies can be considered as having non-constant phase shifts or phase deviations with respect to each other. In various instances, the calibration component 320 can identify at which time all of those multiple sinusoid functions are most in-phase with each other. More specifically, at any particular point in time, the calibration component 320 can compute a respective phase shift between each unique pair of those multiple sinusoids at that particular point in time, and the calibration component 320 can compute an average of those phase shift values. In various cases, the calibration component 320 can identify at which instant in time such average phase shift is minimized or lowest. Conceptually, this can be considered as following those sinusoid functions backward to a phase-minimized chronological instant that occurred prior to when the mass analyzer 304 began detecting ions. In any case, that instant in time can be considered or referred to as the initial time 604(j), and the average phase shift at that instant in time can be considered or referred to as the initial phase 606(j).

In this way, the calibration component 320 can determine an initial time and initial phase for each of the plurality of operational parameter configurations 602, thereby yielding the plurality of initial times 604 and the plurality of initial phases 606.

Next, consider FIG. 9. In embodiments in which the at least one fitted model 402 includes the initial time prediction function 502 and the initial phase prediction function 504, the calibration component 320 can electronically determine what values to assign to the set of time coefficients 503 and to the set of phase coefficients 505, by leveraging the plurality of operational parameter configurations 602, the plurality of initial times 604, and the plurality of initial phases 606.

In particular, the calibration component 320 can electronically reformat the plurality of operational parameter configurations 602 and the plurality of initial times 604 into a set of parameter-vs-initial-time plots 902. In various aspects, the plurality of parameter-vs-initial-time plots 902 can include a total of s plots: one per each operational parameter of the mass analyzer 304. In various instances, each of the plurality of parameter-vs-initial-time plots 902 can be considered as a two-dimensional graph or chart whose ordinate axis represents the plurality of initial times 604 and whose abscissa axis represents the values of a respective operational parameter of the mass analyzer 304 that are specified in the plurality of operational parameter configurations 602. As a non-limiting example, suppose that the operational parameters of the mass analyzer 304 are a push voltage and a central electrode voltage. In such case, the plurality of parameter-vs-initial-time plots 902 can include a total of two plots: a first plot showing initial time as a function of push voltage; and a second plot showing initial time as a function of central electrode voltage. In various aspects, the calibration component 320 can compute or calculate a set of time coefficient values 903, based on the plurality of parameter-vs-initial-time plots 902. In particular, the set of time coefficient values 903 can respectively correspond (e.g., in one-to-one fashion) with the set of time coefficients 503. More specifically, each of the set of time coefficient values 903 can be a particular scalar value that can be assigned to or taken on by a respective one of the set of time coefficients 503. For instance, each of the set of time coefficient values 903 can be a slope, concavity, intercept, area-under-curve, or other characteristic that is exhibited by a respective one of the parameter-vs-initial-time plots 902. In any case, the set of time coefficient values 903 can be considered as being whatever scalar values cause the initial time prediction function 502 to reliably model or otherwise forecast how initial time of the mass analyzer 304 changes across operational parameter configurations of the mass analyzer 304.

Furthermore, in various aspects, the calibration component 320 can electronically reformat the plurality of operational parameter configurations 602 and the plurality of initial phases 606 into a set of parameter-vs-initial-phase plots 904. In various aspects, the plurality of parameter-vs-initial-phase plots 904 can include a total of s plots: one per each operational parameter of the mass analyzer 304. In various instances, each of the plurality of parameter-vs-initial-phase plots 904 can be considered as a two-dimensional graph or chart whose ordinate axis represents the plurality of initial phases 606 and whose abscissa axis represents the values of a respective operational parameter of the mass analyzer 304 that are specified in the plurality of operational parameter configurations 602. As a non-limiting example, suppose again that the operational parameters of the mass analyzer 304 are a push voltage and a central electrode voltage. In such case, the plurality of parameter-vs-initial-phase plots 904 can include a total of two plots: a first plot showing initial phase as a function of push voltage; and a second plot showing initial phase as a function of central electrode voltage. In various aspects, the calibration component 320 can compute or calculate a set of phase coefficient values 905, based on the plurality of parameter-vs-initial-phase plots 904. In particular, the set of phase coefficient values 905 can respectively correspond (e.g., in one-to-one fashion) with the set of phase coefficients 505. More specifically, each of the set of phase coefficient values 905 can be a particular scalar value that can be assigned to or taken on by a respective one of the set of phase coefficients 505. For instance, each of the set of phase coefficient values 905 can be a slope, concavity, intercept, area-under-curve, or other characteristic that is exhibited by a respective one of the parameter-vs-initial-phase plots 904. In any case, the set of phase coefficient values 905 can be considered as being whatever scalar values cause the initial phase prediction function 504 to reliably model or otherwise forecast how initial phase of the mass analyzer 304 changes across operational parameter configurations of the mass analyzer 304.

Now, consider FIG. 10. Once the set of time coefficient values 903 and the set of phase coefficient values 905 are computed, the calibration component 320 can leverage the initial time prediction function 502 and the initial phase prediction function 504 in order to generate the determined initial time 404 and the determined initial phase 406. In particular, the calibration component 320 can assign respective ones of the set of time coefficient values 903 to respective ones of the set of time coefficients 503, such that the set of time coefficients 503 are taking on whatever magnitudes are specified in the set of time coefficient values 903. The calibration component 320 can likewise assign respective ones of the set of phase coefficient values 905 to respective ones of the set of phase coefficients 505, such that the set of phase coefficients 505 are taking on whatever magnitudes are specified in the set of phase coefficient values 905. In various aspects, a user (e.g., a human agent or technician; or a computerized or artificially intelligent agent) associated with the mass spectrometer 302 can controllably (e.g., via any suitable human-computer interface device, such as a keyboard, keypad, or touchscreen) set the mass analyzer 304 to any desired operational parameter configuration, and such configuration can thus be referred to as a user-selected operational parameter configuration 1002. In various instances, the user-selected operational parameter configuration 1002 can specify one or more electrode voltage values 1002(A), an ion injection duration value 1002(B), and an ion trapping duration value 1002(C). In various cases, the user-selected operational parameter configuration 1002 can be considered as a configuration that the user desires to be implemented by the mass analyzer 304. In any case, the calibration component 320 can electronically execute both the initial time prediction function 502 and the initial phase prediction function 504 on the user-selected operational parameter configuration 1002, and such execution can yield the determined initial time 404 and the determined initial phase 406.

As a non-limiting example, the calibration component 320 can feed the user-selected operational parameter configuration 1002 as an input argument to the initial time prediction function 502. Thus, the set of time coefficients 503, which currently or presently have taken on the set of time coefficient values 903, can be mathematically applied (by whatever mathematical operators are included in the initial time prediction function 502) to the user-selected operational parameter configuration 1002. Whatever numerical result is ultimately produced by the initial time prediction function 502 in response to the user-selected operational parameter configuration 1002 can be referred to as the determined initial time 404. In any case, the determined initial time 404 can be the temporal or chronological instant of ejection or excitation toward the mass analyzer 304 if the mass analyzer 304 performed a scan using the user-selected operational parameter configuration 1002.

As another non-limiting example, the calibration component 320 can feed the user-selected operational parameter configuration 1002 as an input argument to the initial phase prediction function 504. Thus, the set of phase coefficients 505, which currently or presently have taken on the set of phase coefficient values 905, can be mathematically applied (by whatever mathematical operators are included in the initial phase prediction function 504) to the user-selected operational parameter configuration 1002. Whatever numerical result is ultimately produced by the initial phase prediction function 504 in response to the user-selected operational parameter configuration 1002 can be referred to as the determined initial phase 406. In any case, the determined initial phase 406 can be whatever phase would be exhibited by squeezed ions at the temporal or chronological instant of ejection/excitation toward the mass analyzer 304 if the mass analyzer 304 performed a scan using the user-selected operational parameter configuration 1002.

Now, consider FIG. 11. In some embodiments, the at least one fitted model 402 can include the time/phase prediction machine learning model 506, rather than the initial time prediction function 502 and the initial phase prediction function 504. In such situations, the calibration component 320 can electronically train the time/phase prediction machine learning model 506 in supervised fashion on the plurality of operational parameter configurations 602, the plurality of initial times 604, and the plurality of initial phases 606.

Prior to beginning such training, the calibration component 320 can initialize in any suitable fashion (e.g., random initialization) the trainable internal parameters (e.g., convolutional kernels, weight matrices, bias values) of the time/phase prediction machine learning model 506.

In various instances, the calibration component 320 can select any suitable operational parameter configuration from the plurality of operational parameter configurations 602. Such selected configuration can be referred to as a training operational parameter configuration 1102, which can specify one or more electrode voltage values 1102(A), an ion injection duration value 1102(B), and an ion trapping duration value 1102(C). In various cases, whichever one of the plurality of initial times 604 corresponds to the training operational parameter configuration 1102 can be referred to as a ground-truth initial time 1106. Likewise, whichever one of the plurality of initial phases 606 corresponds to the training operational parameter configuration 1102 can be referred to as a ground-truth initial phase 1108.

In various aspects, the calibration component 320 can execute the time/phase prediction machine learning model 506 on the training operational parameter configuration 1102, thereby causing the time/phase prediction machine learning model 506 to produce an output 1110. More specifically, suppose that the time/phase prediction machine learning model 506 exhibits a deep learning neural network internal architecture. In such situation, the calibration component 320 can feed the training operational parameter configuration 1102 to an input layer of the time/phase prediction machine learning model 506. In various aspects, the training operational parameter configuration 1102 can complete a forward pass through one or more hidden layers of the time/phase prediction machine learning model 506. In various instances, an output layer of the time/phase prediction machine learning model 506 can compute or calculate the output 1110, based on whatever hidden activation maps or hidden feature maps are produced by the one or more hidden layers during the forward pass.

Note that the format, size, or dimensionality of the output 1110 can be dictated by the number, arrangement, sizes, or other characteristics of the neurons, convolutional kernels, attention blocks, or other internal parameters of the output layer (or of any other layers) of the time/phase prediction machine learning model 506. Accordingly, the output 1110 can be forced to have any desired format, size, or dimensionality, by adding, removing, or otherwise adjusting characteristics of the output layer (or of any other layers) of the time/phase prediction machine learning model 506. In particular, the output 1110 can be forced to have the same format, size, or dimensionality as a concatenation of the ground-truth initial time 1106 and the ground-truth initial phase 1108. Accordingly, the output 1110 can be considered as the predicted or inferred initial time and initial phase that the time/phase prediction machine learning model 506 believes that the mass analyzer 304 will exhibit if the mass analyzer 304 is set to the training operational parameter configuration 1102. In contrast, the ground-truth initial time 1106 and the ground-truth initial phase 1108 can be respectively considered as the correct or accurate initial time and initial phase that the mass analyzer 304 is known or deemed to exhibit when the mass analyzer 304 is set to the training operational parameter configuration 1102. Note that, if the time/phase prediction machine learning model 506 has so far undergone no or little training, then the output 1110 can be highly inaccurate. In other words, the output 1110 can be very different from the concatenation of the ground-truth initial time 1106 and the ground-truth initial phase 1108.

In various aspects, the calibration component 320 can compute an error 1112 (e.g., mean absolute error (MAE), mean squared error (MSE), cross-entropy error) between: the output 1110; and the concatenation of the ground-truth initial time 1106 and the ground-truth initial phase 1108. In various instances, the calibration component 320 can incrementally update the trainable internal parameters of the time/phase prediction machine learning model 506 via backpropagation (e.g., stochastic gradient descent) that is driven by the error 1112.

In various cases, the calibration component 320 can repeat such execution-and-update procedure for any suitable number of training operational parameter configurations (e.g., for each of the plurality of operational parameter configurations 602). This can ultimately cause the trainable internal parameters of the time/phase prediction machine learning model 506 to become iteratively optimized for accurately inferring what initial time and initial phase the mass analyzer 304 will have for any given or inputted operational parameter configuration. In various aspects, any suitable training batch sizes, any suitable error/loss functions, or any suitable training termination criteria can be utilized during such training.

Although the herein disclosure mainly describes the time/phase prediction machine learning model 506 as being trained in supervised fashion, this is a mere non-limiting example for ease of explanation and illustration. In various embodiments, any other suitable training paradigms can be used to train the time/phase prediction machine learning model 506, such as unsupervised training, semi-supervised training, or reinforcement learning, any of which may be federated or unfederated.

Next, consider FIG. 12. Once the time/phase prediction machine learning model 506 is trained, the calibration component 320 can execute it on the user-selected operational parameter configuration 1002, so to identify or determine the determined initial time 404 and the determined initial phase 406. For instance, the calibration component 320 can feed the user-selected operational parameter configuration 1002 to the input layer of the time/phase prediction machine learning model 506, the user-selected operational parameter configuration 1002 can complete a forward pass through the one or more hidden layers of the time/phase prediction machine learning model 506, and the output layer of the time/phase prediction machine learning model 506 can compute or calculate both the determined initial time 404 and the determined initial phase 406 based on whatever hidden activation maps or hidden feature maps are produced by the one or more hidden layers during the forward pass.

No matter how the at least one fitted model 402 is configured or structured (e.g., made up of the initial time prediction function 502 and the initial phase prediction function 504; or instead made up of the time/phase prediction machine learning model 506), the calibration component 320 can identify the determined initial time 404 and the determined initial phase 406 by feeding the user-selected operational parameter configuration 1002 as an input argument to the at least one fitted model 402.

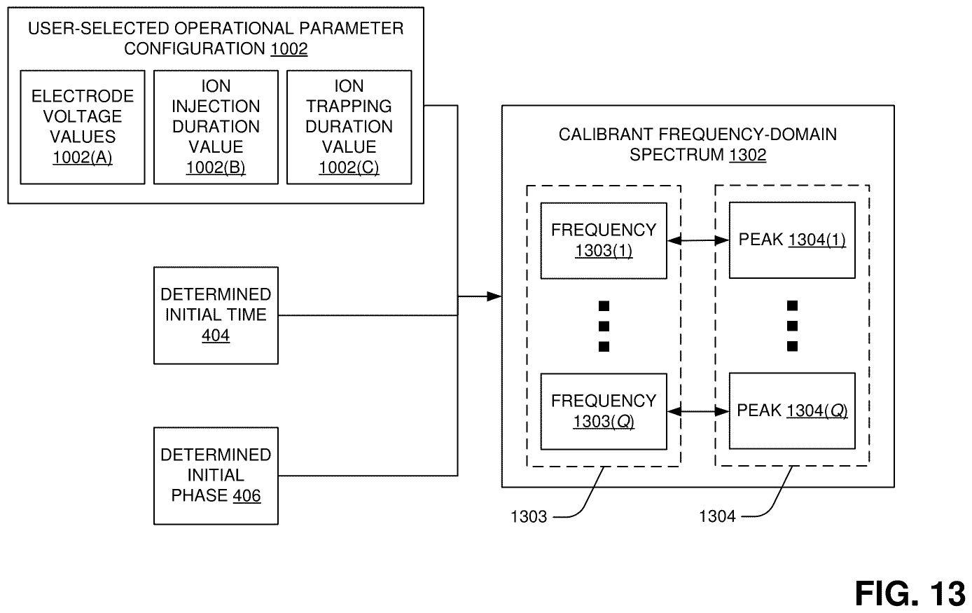

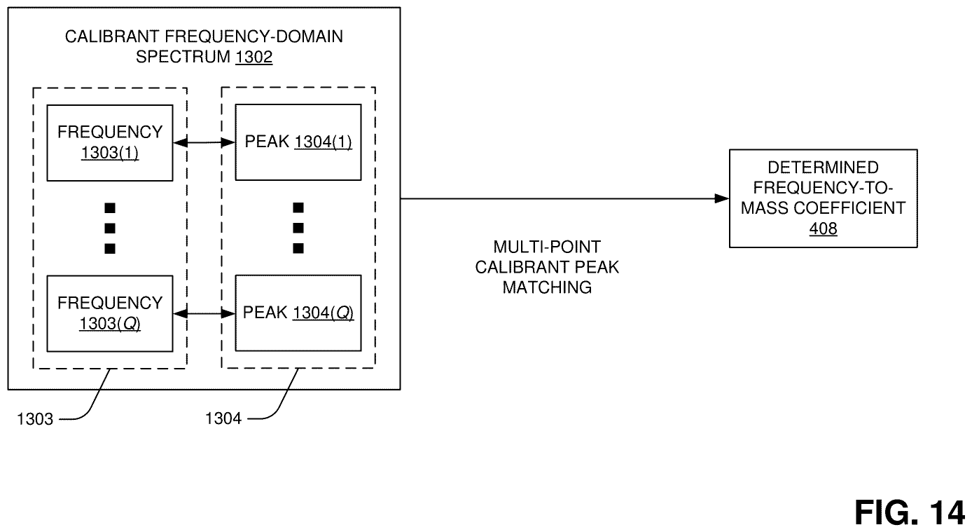

In various embodiments, the calibration component 320 can utilize the determined initial time 404 and the determined initial phase 406 so as to identify or determine the determined frequency-to-mass coefficient 408. Non-limiting aspects are described with respect to FIGS. 13-14.

Consider FIG. 13. In various aspects, the calibration component 320 can cause the mass spectrometer 302, and thus the mass analyzer 304, to perform a single scan on any suitable calibrant using the user-selected operational parameter configuration 1002. In other words, the calibration component 320 can electronically instruct, electronically command, or otherwise electronically cause the mass spectrometer 302 to run or activate while the configurable operational parameters of the mass analyzer 304 are set or configured to whatever specific values are specified in the user-selected operational parameter configuration 1002. Such scan can cause the mass spectrometer 302 to record, yield, or otherwise produce a calibrant time-domain signal (not shown), which can be considered as a collection of time-intensity tuples measured or detected for the calibrant. In various instances, the calibration component 320 can perform on that calibrant time-domain signal an eFT operation. Recall that eFT can be considered as a mathematical transformation that takes three input arguments: a time-domain signal; an initial time; and an initial phase; and that produces as output a frequency-domain spectrum. Accordingly, the calibration component 320 can perform eFT on the calibrant time-domain signal, on the determined initial time 404, and on the determined initial phase 406. Such performance of eFT can be considered as converting the calibrant time-domain signal into a calibrant frequency-domain spectrum 1302.

In various aspects, the calibrant frequency-domain spectrum 1302 can be a graph, plot, or chart of recorded intensity as a function of oscillatory frequency. In other words, the calibrant frequency-domain spectrum 1302 can be a collection of tuples, each tuple indicating a unique oscillatory frequency and a respective intensity value that was recorded, measured, or detected by the mass spectrometer 302 at that unique oscillatory frequency. In still other words, an abscissa axis of the calibrant frequency-domain spectrum 1302 can represent oscillatory frequency of various ions, whereas an ordinate axis of the calibrant frequency-domain spectrum 1302 can represent relative ion abundance. In various instances, the calibrant frequency-domain spectrum 1302 can exhibit, have, or otherwise contain a plurality of peaks 1304. In various cases, the plurality of peaks 1304 can include a total of q peaks for any suitable positive integer q>1: a peak 1304(1) to a peak 1304(q). In various aspects, each of the plurality of peaks 1304 can be considered as a locally-maximum relative ion abundance value that is located at a respective or unique oscillatory frequency. As a non-limiting example, the peak 1304(1) can be located at or centered about a frequency 1303(1), whereas the peak 1304(q) can be located at or centered about a frequency 1303(q). Note that the frequency 1303(1) to the frequency 1303(q) can collectively be considered as forming a plurality of frequencies 1303.

Next, consider FIG. 14. In various aspects, the calibration component 320 can compute or calculate the calibrated frequency-to-mass coefficient 408, based on the calibrant frequency-domain spectrum 1302. Indeed, it can be desired for the plurality of peaks 1304 to be tagged with respective m/z values rather than with respective oscillatory frequency values. As explained above, frequency (w) of a given peak and m/z of that given peak can be mapped together in a first-order approximation using the following formula:

$$\frac{m}{z} = \frac{k}{{ω}^{2}}$$

where k is an empirically-determined frequency-to-mass mapping coefficient. As also explained above, when given any two peaks, say peak A and peak B, their frequencies and m/z values can be related via ratios as follows:

$$\frac{{ω}_{A}}{{ω}_{B}} = \sqrt{\frac{{( m / z )}_{B}}{{( m / z )}_{A}}}$$

Now, because the calibrant frequency-domain spectrum 1302 is generated from a standardized calibrant that has (by virtue of it being a calibrant) a known mass spectrum (not shown), such known mass spectrum can indicate its own plurality of peaks each being located at a respective m/z value. In various aspects, the calibration component 320 can perform multi-point calibrant peak matching between the calibrant frequency-domain spectrum 1302 and that known mass spectrum. In particular, the calibration component 320 can select any pair of peaks from the plurality of peaks 1304. The frequencies of such selected pair of peaks can be indicated in the plurality of frequencies 1303. Thus, the calibration component can calculate a measured frequency ratio (e.g., empirically-obtained version of

$$\frac{{ω}_{A}}{{ω}_{B}} )$$

of that selected pair of peaks. In various instances, the calibration component 320 can then compute a respective theoretical frequency ratio using m/z values

$$( e . g . , \sqrt{\frac{{( m / z )}_{B}}{{( m / z )}_{A}}} )$$

for each unique pair of peaks in the known mass spectrum. Accordingly, the calibration component 320 can search through those theoretical frequency ratios until one is found that matches (e.g., is within any suitable threshold margin of) the measured frequency ratio of the selected pair of peaks. Once a match is found, the calibration component 320 can be considered as now knowing what respective m/z value corresponds each of the selected pair of peaks. By performing this comparison or search for each unique pair of peaks in the plurality of peaks 1304, each of the plurality of peaks 1304 can be assigned a respective m/z value with high accuracy or reliability. Thus, the calibration component 320 can utilize the above first-order approximation formula to compute a respective k-value for each of the plurality of peaks 1304 (e.g., by multiplying a given peak's m/z value with the square of the given peak's frequency; or by least-square fit of all the theoretical m/z values and experimentally located frequency pairs). In various cases, the calibrated frequency-to-mass coefficient 408 can be equal to or otherwise based on any suitable aggregation of the k-values respectively corresponding to the plurality of peaks 1304 (e.g., can be equal to the average of all those k-values).

It should be understood or otherwise appreciated that, in situations where higher-order mapping between frequency and m/z is implemented, more than one calibration frequency-to-mass coefficient 408 can be determined analogously as described with respect to FIG. 14.

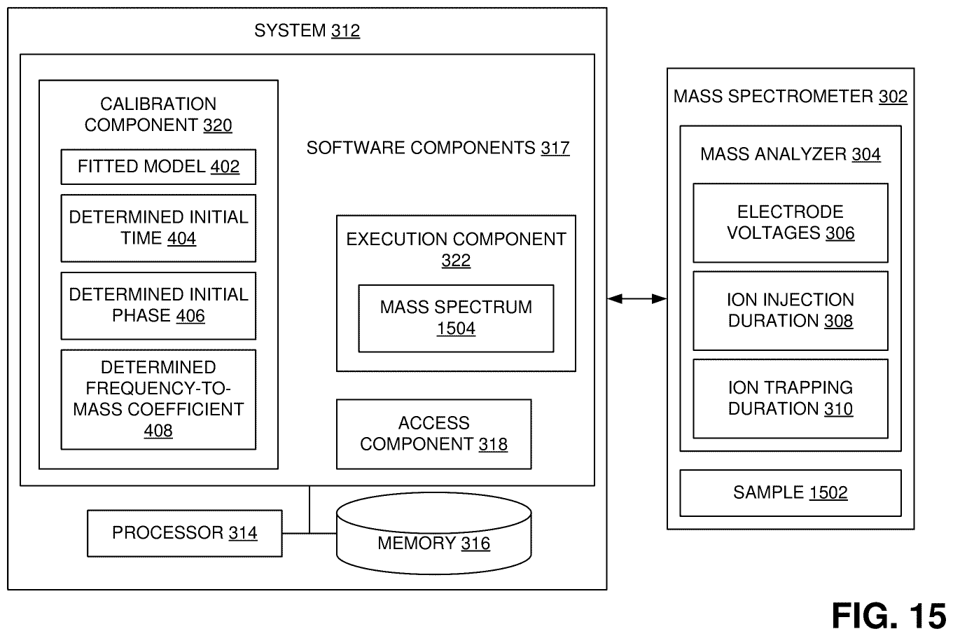

FIG. 15 illustrates a block diagram of an example, non-limiting system including a sample and a mass spectrum that can facilitate rapid mass analyzer calibration via initial time and phase prediction in accordance with one or more embodiments described herein.

In various embodiments, the user can load a sample 1502 into the mass spectrometer 302. In various aspects, the sample 1502 can be any suitable aqueous solution or specimen which is desired to be reliably or accurately analyzed by the mass spectrometer 302 using the user-selected operational parameter configuration 1002. In various instances, the execution component 322 can electronically facilitate such analysis, by leveraging the determined initial time 404, the determined initial phase 406, and the determined frequency-to-mass coefficient 408. In particular, the execution component 322 can cause the mass spectrometer 302, and thus the mass analyzer 304, to perform a single scan on the sample 1502 using the user-selected operational parameter configuration 1002. In other words, the execution component 322 can electronically instruct, electronically command, or otherwise electronically cause the mass spectrometer 302 to run or activate while the configurable operational parameters of the mass analyzer 304 are set or configured to whatever specific values are specified in the user-selected operational parameter configuration 1002. Such scan can cause the mass spectrometer 302 to record, yield, or otherwise produce a time-domain signal (not shown), which can be considered as a collection of time-intensity tuples detected or measured for the sample 1502. In various instances, the execution component 322 can perform on that time-domain signal an eFT operation using the determined initial time 404 and the determined initial phase 406. Such performance of eFT can be considered as converting the time-domain signal into a frequency-domain spectrum (not shown). In various instances, the execution component 322 can bring that frequency-domain spectrum into the m/z domain, by applying the determined frequency-to-mass coefficient 408 to that frequency-domain spectrum. For instance, if the determined frequency-to-mass coefficient 408 is obtained using the above first-order approximation, the execution component 322 can square each frequency value indicated in the frequency-domain spectrum and can respectively divide the determined frequency-to-mass coefficient 408 by that square. This can be considered as translating the abscissa axis of the frequency-domain spectrum from oscillatory frequency values to m/z values. After application of the determined frequency-to-mass coefficient 408, the resultant spectrum can be considered as showing relative ion abundance or intensity as a function of m/z for the sample 1502. Thus, such resultant spectrum can be referred to as a mass spectrum 1504. In various aspects, the execution component 322 can electronically transmit the mass spectrum 1504 to any other suitable computing device, or the execution component 322 can electronically render the mass spectrum 1504 on any suitable computer screen or electronic display.

Note that, whenever the user (e.g., which may be a human agent or a computerized agent) adjusts the operational parameter configuration of the mass analyzer 304, newly-determined initial times and phases can be nearly instantaneously predicted by the at least one fitted model 402, without having to perform any additional scans by the mass analyzer 304. In this way, the at least one fitted model 402 can be considered as saving significant amounts of calibration time in situations where repeated or numerous adjustments to the operational parameters of the mass analyzer 304 are required (e.g., such as during mass analyzer tuning procedures).

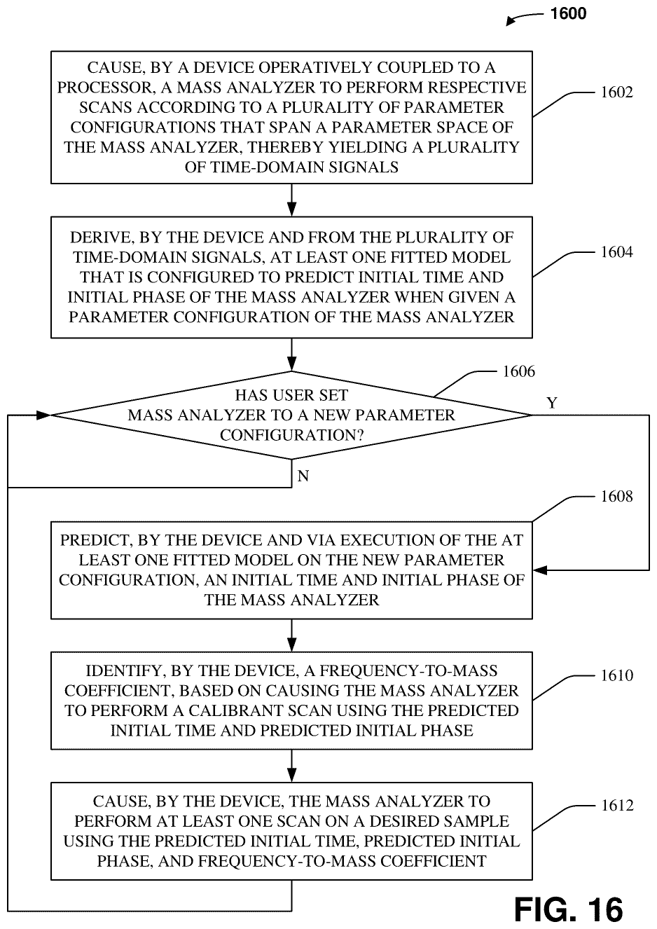

FIG. 16 illustrates a flow diagram of an example, non-limiting computer-implemented method 1600 that can facilitate rapid mass analyzer calibration via initial time and phase prediction in accordance with one or more embodiments described herein.

In various embodiments, act 1602 can include causing, by a device (e.g., via 320), a mass analyzer (e.g., 304) to perform respective scans according to a plurality of parameter configurations (e.g., 602) that span a parameter space of the mass analyzer, thereby yielding a plurality of time-domain signals (e.g., such as 702).

In various aspects, act 1604 can include deriving, by the device (e.g., via 320) and from the plurality of time-domain signals, at least one fitted mode (e.g., 402) that is configured to predict initial time and initial phase of the mass analyzer when given a parameter configuration of the mass analyzer.

In various instances, act 1606 can include determining, by the device (e.g., via 320), whether a user has set the mass analyzer to a new parameter configuration (e.g., 1002). If not, the computer-implemented method 1600 can repeat act 1606. If so, the computer-implemented method 1600 can proceed to act 1608.

In various cases, act 1608 can include predicting, by the device (e.g., via 320) and via execution of the at least one fitted model on the new parameter configuration, an initial time (e.g., 404) and an initial phase (e.g., 406) of the mass analyzer.

In various aspects, act 1610 can include identifying, by the device (e.g., via 320), a frequency-to-mass coefficient (e.g., 408), based on causing the mass analyzer to perform a calibrant scan using the predicted initial time and predicted initial phase.

In various instances act 1612 can include causing, by the device (e.g., via 322), the mass analyzer to perform at least one scan on a desired sample (e.g., 1502) using the predicted initial time, predicted initial phase, and frequency-to-mass coefficient, thereby yielding at least one mass spectrum (e.g., 1504) for the desired sample. In various cases, the computer-implemented method 1600 can proceed back to act 1606.

Note that only act 1602, act 1610, and act 1612 can be considered as having an appreciable or non-negligible time-consumption, since only those acts involve the performance of scans by the mass analyzer (e.g., act 1604, act 1606, and act 1608 instead involve software computation or processing which can be considered as nearly instantaneous with today's computing speeds). Furthermore, note that act 1612 can be considered as the performance of one or more scans after the mass analyzer has undergone time, phase, and frequency-to-mass calibration. So, only act 1602 and act 1610 can be considered as meaningfully contributing to the amount of time needed or required to facilitate time, phase, and frequency-to-mass calibration of the mass analyzer. Recall that a single scan performed by the mass analyzer can consume mere milliseconds (e.g., about 30 to 50 milliseconds in many cases). Since act 1610 involves causing the mass analyzer to perform a single scan, act 1610 can consume mere milliseconds. Since act 1602 involves causing the mass analyzer to perform multiple scans, act 1610 can consume some integer multiple of those mere milliseconds. However, the total number of scans implemented in act 1602 can be kept minimal or small by strategically selecting the plurality of parameter configurations (e.g., such that each selected configuration is an extremity or midpoint within the parameter space of the mass analyzer). Accordingly, in practice, act 1602 can consume about one second or less. Therefore, the total amount of time required for the mass analyzer to undergo time, phase, and frequency-to-mass calibration can be equal to: an up-front consumption of about one second; plus an ongoing consumption of mere milliseconds for each new parameter configuration for which time, phase, and frequency-to-mass calibration is to be performed. This can be considered as orders of magnitude faster than existing techniques, which instead consume several minutes for each new parameter configuration for which time, phase, and frequency-to-mass calibration is to be performed.

Although various embodiments described herein mainly discuss generation of a single determined initial time, a single determined initial phase, and a single determined frequency-to-mass coefficient for the mass analyzer 304, these are mere non-limiting examples for ease of explanation and illustration. In various aspects, the mass analyzer 304 can be configured to operate according to any of a plurality of analytical mass ranges (e.g., a high analytical mass range, a low analytical mass range, an ultra-low analytical mass range). In such situations, various embodiments described herein can involve generation of a respective determined initial time, a respective determined initial phase, and a respective determined frequency-to-mass coefficient per each of that plurality of analytical mass ranges (e.g., a first determined initial time, a first determined initial phase, and a first determined frequency-to-mass coefficient for the high analytical mass range when given any particular operational parameter configuration of the mass analyzer 304; a second determined initial time, a second determined initial phase, and a second determined frequency-to-mass coefficient for the low analytical mass range when given the particular operational parameter configuration of the mass analyzer 304; a third determined initial time, a third determined initial phase, and a third determined frequency-to-mass coefficient for the ultra-low analytical mass range when given the particular operational parameter configuration of the mass analyzer 304).

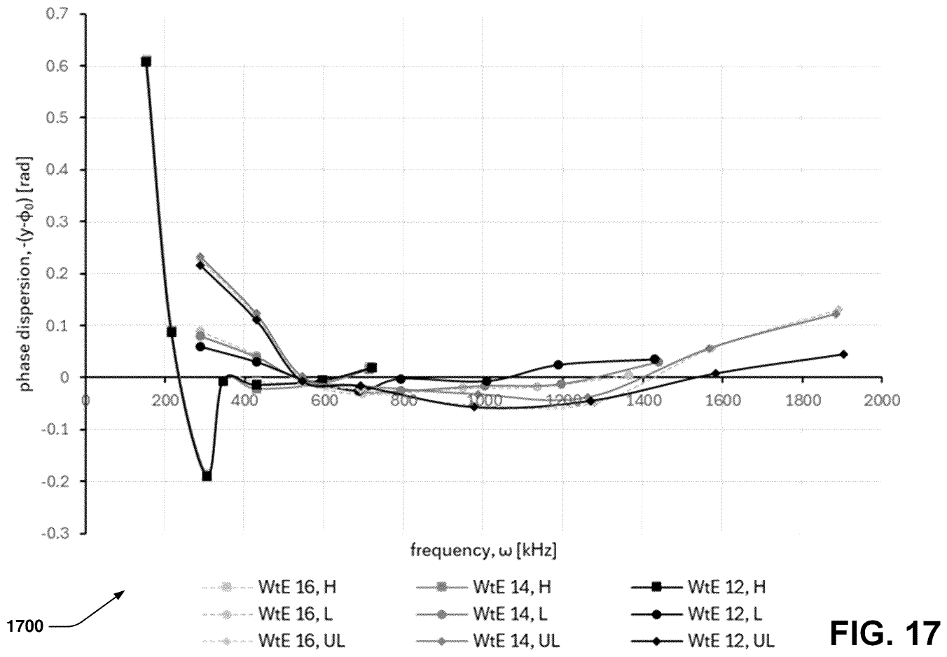

FIGS. 17-21 illustrate example, non-limiting experimental results in accordance with one or more embodiments described herein.

FIG. 17 includes a graph 1700. The graph 1700 shows some eFT dispersion data recorded during various experiments performed by the present inventor. Specifically, the graph 1700 shows eFT dispersion data across different analytical mass ranges (e.g., “H” represents high; “L” represents low; “UL” represents ultra-low) and across different waves-to-eject (denoted “WIE”) settings, where WE can be considered as an operational parameter of a mass analyzer. Note how the eFT dispersion data for each analytical mass range changes very little as WtE is adjusted (e.g., the eFT dispersion data produced for H all neatly falls on top of each other, even though WtE is adjusted from 16 to 14 to 12; the eFT dispersion data produced for L all neatly falls on top of each other, even though WtE is adjusted from 16 to 14 to 12; the eFT dispersion data produced for UL all neatly falls on top of each other, even though WtE is adjusted from 16 to 14 to 12). In other words, this means that eFT dispersion data (e.g., the shape of second-order dependencies of phase with respect to m/z) does not meaningfully or appreciably change with operational parameters. Because of this original insight garnered from her own thorough experimentation, the present inventor realized that the multitude of calibration scans implemented by existing techniques can actually be considered unnecessary and thus devised various embodiments described herein (e.g., although the dispersion data can still need to be measured once, it need not be recomputed for each new operational parameter configuration).

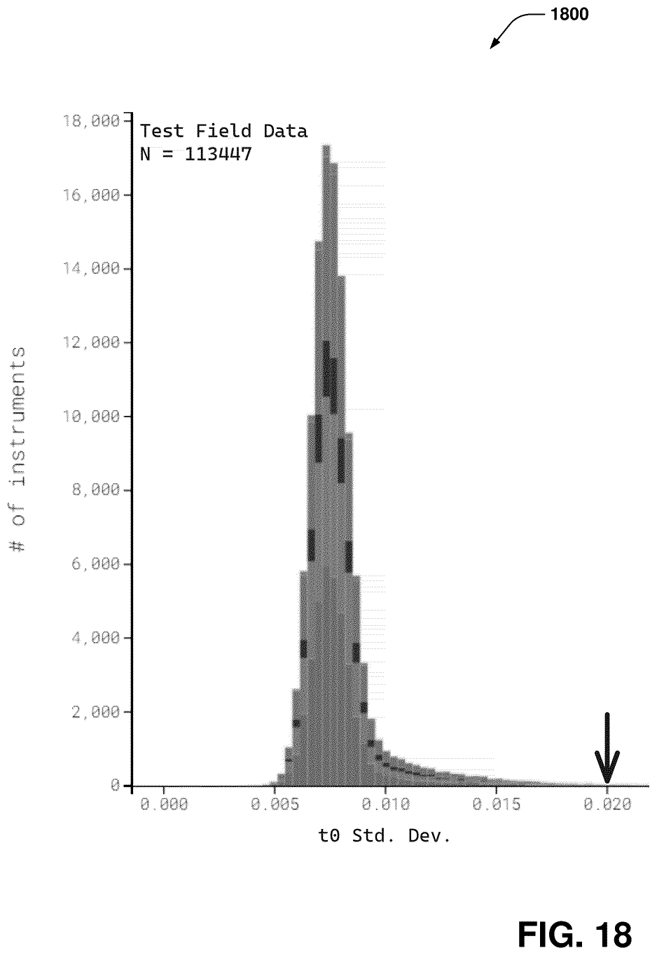

FIG. 18 includes a histogram 1800. The histogram 1800 shows a distribution of standard deviations of individual measurements of initial time from a large number (e.g., 113447) of scan collections, each collection having 50 to 100 single scans. As shown, the standard deviation has an average of about 0.0075, with a maximum of about 0.02. The present inventor realized that such miniscule standard deviations allow for initial time to be accurately or reliably measured via a single scan. In other words, such miniscule standard deviations helped the present inventor to realize that the multitude of calibration scans implemented by existing techniques can again be considered unnecessary. An analogous histogram was obtained for standard deviation of initial phase.

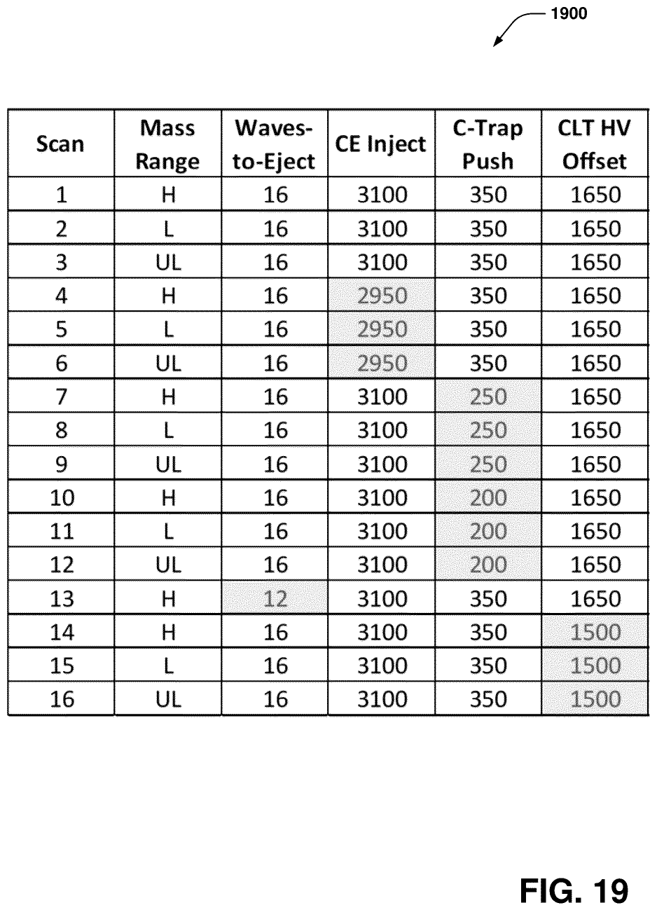

FIG. 19 includes a table 1900. The present inventor experimentally reduced to practice an embodiment described herein. In such experiment, the mass analyzer 304 had three analytical mass ranges: H, L, and UL. Also in such experiment, the mass analyzer 304 had four operational parameters which affected initial time and initial phase: Wave-to-Eject; Central Electrode (CE) Inject voltage; C-Trap Push voltage; and C-Trap High Voltage (CLT HV) offset. In such experiment, the at least one fitted model 402 included the initial time prediction function 502 and the initial phase prediction function 504, and such functions were generated from the scans whose parameters are shown in the table 1900.

Specifically, the initial time prediction function 502 was:

$$\text{?} = {φ}_{ref} - {m}_{PV , phase} ( {PV}_{ref} - P V ) - {m}_{H V} ( H {V}_{ref} - H V ) - {m}_{C E , p h a s e} ( C {E}_{ref} - C E )$$

where PV represents the C-Trap Push voltage implemented by the mass analyzer 304; where HV represents the CLT HV offset implemented by the mass analyzer 304; where CE represents the CE Inject voltage implemented by the mass analyzer 304; where [symbol] represents the determined initial phase 406 for any given analytical mass range; where φ_{ref} represents the measured initial phase for the given analytical mass range at a reference C-Trap Push voltage denoted PV_{ref}; where PV_{ref} is 350 volts if PV>250 volts and is 250 volts otherwise (e.g., this means that Pref can be measured in one of scans 1, 2, 3, 7, 8, or 9); where m_{pv,phase} represents the slope of a plot of initial phase versus C-Trap Push voltage for the given analytical mass range (e.g., such plot can be obtained from the results of scans 1, 7, and 10 for H; or from the results of 2, 8, and 11 for L; or from the results of 3, 9, and 12 for UL); where m_{HV} represents the slope of a plot of initial phase versus CLT HV offset for the given analytical mass range (e.g., such plot can be obtained from the results of scans 1 and 14 for H; or from the results of scans 2 and 15 for L; or from the results of scans 3 and 16 for UL); where HV_{ref} is 1650; where m_{CE,phase} is the slope of a plot of initial phase versus CE Inject voltage for the given analytical mass range (e.g., such plot can be obtained from the results of scans 1 and 4 for H; or from the results of scans 2 and 5 for L; or from the results of scans 3 and 6 for UL); and where CE_{ref} is 3100. Note that m_{PV}, m_{HV}, and m_{CE} can be considered as belonging to the set of phase coefficients 505.

Additionally, the initial phase prediction function 504 was:

$$\text{?} = {t}_{ref} - {m}_{W} ( {W}_{ref} - W ) - {m}_{C E , t i m e} ( C {E}_{ref} - C E ) - ( {b}_{range} - {m}_{{b}_{r a n g e} , C E} ( C {E}_{ref} - C E ) ) - {m}_{PV , time} ( P {V}_{ref} - P V )$$

where [symbol] represents the determined initial time 404 for any given analytical mass range; where t_{ref} represents the measured initial time from scan 1; where m_{W} represents the slope of a plot of initial time versus Waves-to-Eject (e.g., such plot can be obtained from the results of scans 1 and 13 for H); where m_{CE,time} represents the slope of a plot of initial time versus CE Inject for the given analytical mass range (e.g., such plot can be obtained from the results of scans 1 and 4 for H; or from the results of scans 2 and 5 for L; or from the results of scans 3 and 6 for UL); where m_{PV,time} represents the slope of a plot of initial time versus C-Trap Push for the given analytical mass range (e.g., such plot can be obtained from the results of scans 1, 7, and 10 for H; or from the results of 2, 8, and 11 for L; or from the results of 3, 9, and 12 for UL); where b_{range} represents a mass-range-specific offset correction determined from scans 1 and 2 or 1 and 3 and where b_{range}=0 when the analytical mass range is H; and where m_{b}_{_{range}}_{,CE} is the slope of a plot of b_{range} versus CE Inject voltage (e.g., determined from scans 4 and 5 for L; determined from scans 4 and 6 for UL; and equal to 0 for H). Note that m_{PV}, m_{HV}, m_{b}_{_{range}}_{,CE}, and m_{CE} can be considered as belonging to the set of time coefficients 503.

In various aspects, table 1900 can be considered as showing the plurality of operational parameter configurations 602 that was implemented for the above reduction-to-practice formulations of the initial time prediction function 502 and the initial phase prediction function 504. Note that a mere 16 configurations, and thus 16 scans, were sufficient to build or construct the initial time prediction function 502 and the initial phase prediction function 504. The performance of such 16 scans consumed about half a second in total. Note that the such a low or small number of scans was made possible by strategically selecting the Waves-to-Eject, CE Inject, C-Trap Push, and CLT HV Offset parameters to be at extremities or midpoints within their respective domains. For example, the minimum possible value and maximum possible value of Waves-to-Eject were 12 and 16 (unitless) respectively. Notice how no other intermediary values of Waves-to-Eject were implemented in the 16 scans. As another example, the minimum possible value and maximum possible value of CE Inject were 2950 volts and 3100 volts respectively. Notice how no other intermediary values of CE Inject were implemented in the 16 scans. As yet another example, the minimum possible value and maximum possible value of CLT HV Offset were 1500 volts and 1650 volts respectively. Notice how no other intermediary values of CLT HV Offset were implemented in the 16 scans. As even another example, the minimum possible value and maximum possible value of C-Trap Push were 200 volts and 350 volts respectively. Notice how no other intermediary values of C-Trap Push, other than its midpoint of 250 volts, were implemented in the 16 scans.

It should be understood that the above formulations are mere non-limiting examples and that any other formulations of the initial time prediction function 502 and the initial phase prediction function 504 are possible.

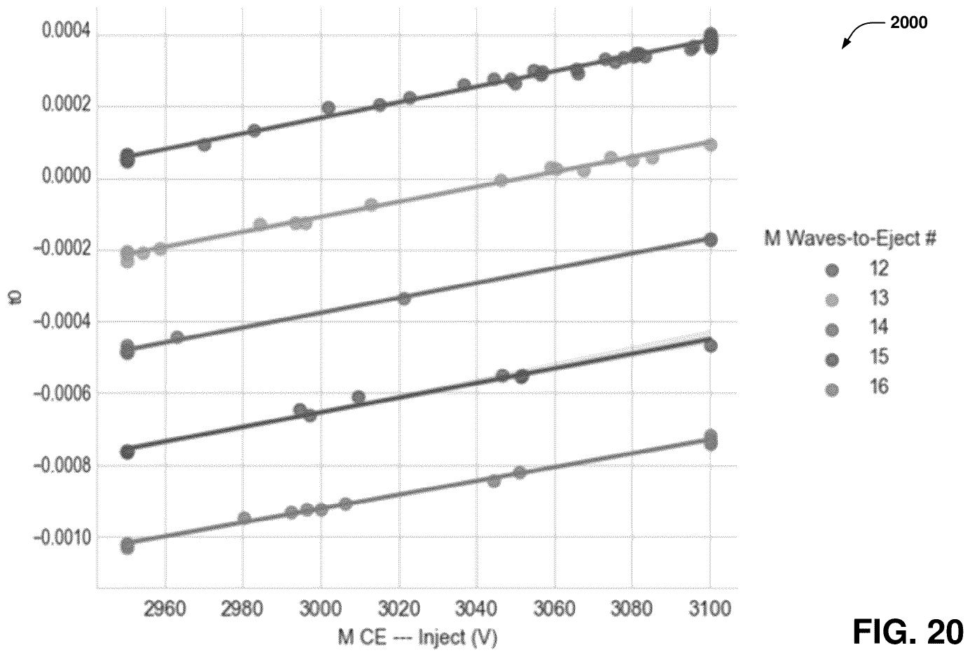

FIG. 20 includes a graph 2000. The graph 2000 shows a plot of initial time versus CE Inject across different Waves-to-Eject settings. As shown, initial time varies about linearly with CE Inject, and so a slope (e.g., m_{CE,time}) can be computed from the graph 2000 and used to construct the initial time prediction function 502. The graph 2000 can also be considered as showing how initial time varies with Waves-to-Eject, meaning that another slope (e.g., m_{W}) can be computed from the graph 2000 and used to construct the initial time prediction function 502. Analogous parameter-vs-initial-time plots and parameter-vs-initial-phase plots were obtained for CLT HV Offset and C-Trap Push.

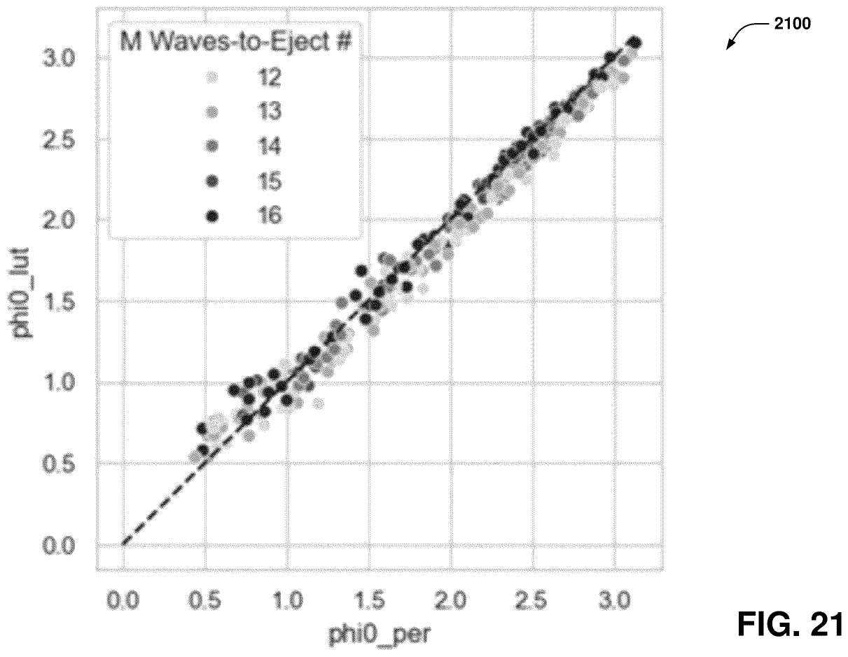

FIG. 21 includes a graph 2100. The graph 2100 compares the performance of the above formulation of the initial phase prediction function 504 (e.g., denoted as “LUT”) to ground-truth initial phases (denoted as “per”). Specifically, for each of several operational parameter configurations, a ground-truth initial phase was obtained by existing techniques and an initial phase was produced by the initial phase prediction function 504. As shown, the ordinate axis of the graph 2100 represents initial phases predicted by the initial phase prediction function 504, whereas the abscissa axis of the graph 2100 represents ground-truth initial phases. Note how the graph 2100 depicts a neat y=x diagonal line, which indicates that initial phases produced by the initial phase prediction function 504 reliably matched the ground-truth initial phases. This helps to demonstrate the efficacy of various embodiments described herein. Analogous graphs were obtained for the initial time prediction function 502.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ artificial intelligence to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence(class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

In order to provide additional context for various embodiments described herein, FIG. 22 and the following discussion are intended to provide a brief, general description of a suitable computing environment 2200 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 22, the example environment 2200 for implementing various embodiments of the aspects described herein includes a computer 2202, the computer 2202 including a processing unit 2204, a system memory 2206 and a system bus 2208. The system bus 2208 couples system components including, but not limited to, the system memory 2206 to the processing unit 2204. The processing unit 2204 can be any of various commercially available processors. Dual microprocessors and other multi-processor architectures can also be employed as the processing unit 2204.

The system bus 2208 can be any of several types of bus structure that can further interconnect to a memory bus (with or without a memory controller), a peripheral bus, and a local bus using any of a variety of commercially available bus architectures. The system memory 2206 includes ROM 2210 and RAM 2212. A basic input/output system (BIOS) can be stored in a non-volatile memory such as ROM, erasable programmable read only memory (EPROM), EEPROM, which BIOS contains the basic routines that help to transfer information between elements within the computer 2202, such as during startup. The RAM 2212 can also include a high-speed RAM such as static RAM for caching data.

The computer 2202 further includes an internal hard disk drive (HDD) 2214 (e.g., EIDE, SATA), one or more external storage devices 2216 (e.g., a magnetic floppy disk drive (FDD) 2216, a memory stick or flash drive reader, a memory card reader, etc.) and a drive 2220, e.g., such as a solid state drive, an optical disk drive, which can read or write from a disk 2222, such as a CD-ROM disc, a DVD, a BD, etc. Alternatively, where a solid state drive is involved, disk 2222 would not be included, unless separate. While the internal HDD 2214 is illustrated as located within the computer 2202, the internal HDD 2214 can also be configured for external use in a suitable chassis (not shown). Additionally, while not shown in environment 2200, a solid state drive (SSD) could be used in addition to, or in place of, an HDD 2214. The HDD 2214, external storage device(s) 2216 and drive 2220 can be connected to the system bus 2208 by an HDD interface 2224, an external storage interface 2226 and a drive interface 2228, respectively. The interface 2224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 2202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 2212, including an operating system 2230, one or more application programs 2232, other program modules 2234 and program data 2236. All or portions of the operating system, applications, modules, or data can also be cached in the RAM 2212. The systems and methods described herein can be implemented utilizing various commercially available operating systems or combinations of operating systems.

Computer 2202 can optionally comprise emulation technologies. For example, a hypervisor (not shown) or other intermediary can emulate a hardware environment for operating system 2230, and the emulated hardware can optionally be different from the hardware illustrated in FIG. 22. In such an embodiment, operating system 2230 can comprise one virtual machine (VM) of multiple VMs hosted at computer 2202. Furthermore, operating system 2230 can provide runtime environments, such as the Java runtime environment or the .NET framework, for applications 2232. Runtime environments are consistent execution environments that allow applications 2232 to run on any operating system that includes the runtime environment. Similarly, operating system 2230 can support containers, and applications 2232 can be in the form of containers, which are lightweight, standalone, executable packages of software that include, e.g., code, runtime, system tools, system libraries and settings for an application.

Further, computer 2202 can be enable with a security module, such as a trusted processing module (TPM). For instance with a TPM, boot components hash next in time boot components, and wait for a match of results to secured values, before loading a next boot component. This process can take place at any layer in the code execution stack of computer 2202, e.g., applied at the application execution level or at the operating system (OS) kernel level, thereby enabling security at any level of code execution.

A user can enter commands and information into the computer 2202 through one or more wired/wireless input devices, e.g., a keyboard 2238, a touch screen 2240, and a pointing device, such as a mouse 2242. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2204 through an input device interface 2244 that can be coupled to the system bus 2208, but can be connected by other interfaces, such as a parallel port, an IEEE 1394 serial port, a game port, a USB port, an IR interface, a BLUETOOTH® interface, etc.

A monitor 2246 or other type of display device can be also connected to the system bus 2208 via an interface, such as a video adapter 2248. In addition to the monitor 2246, a computer typically includes other peripheral output devices (not shown), such as speakers, printers, etc.

The computer 2202 can operate in a networked environment using logical connections via wired or wireless communications to one or more remote computers, such as a remote computer(s) 2250. The remote computer(s) 2250 can be a workstation, a server computer, a router, a personal computer, portable computer, microprocessor-based entertainment appliance, a peer device or other common network node, and typically includes many or all of the elements described relative to the computer 2202, although, for purposes of brevity, only a memory/storage device 2252 is illustrated. The logical connections depicted include wired/wireless connectivity to a local area network (LAN) 2254 or larger networks, e.g., a wide area network (WAN) 2256. Such LAN and WAN networking environments are commonplace in offices and companies, and facilitate enterprise-wide computer networks, such as intranets, all of which can connect to a global communications network, e.g., the Internet.

When used in a LAN networking environment, the computer 2202 can be connected to the local network 2254 through a wired or wireless communication network interface or adapter 2258. The adapter 2258 can facilitate wired or wireless communication to the LAN 2254, which can also include a wireless access point (AP) disposed thereon for communicating with the adapter 2258 in a wireless mode.

When used in a WAN networking environment, the computer 2202 can include a modem 2260 or can be connected to a communications server on the WAN 2256 via other means for establishing communications over the WAN 2256, such as by way of the Internet. The modem 2260, which can be internal or external and a wired or wireless device, can be connected to the system bus 2208 via the input device interface 2244. In a networked environment, program modules depicted relative to the computer 2202 or portions thereof, can be stored in the remote memory/storage device 2252. It will be appreciated that the network connections shown are example and other means of establishing a communications link between the computers can be used.

When used in either a LAN or WAN networking environment, the computer 2202 can access cloud storage systems or other network-based storage systems in addition to, or in place of, external storage devices 2216 as described above, such as but not limited to a network virtual machine providing one or more aspects of storage or processing of information. Generally, a connection between the computer 2202 and a cloud storage system can be established over a LAN 2254 or WAN 2256 e.g., by the adapter 2258 or modem 2260, respectively. Upon connecting the computer 2202 to an associated cloud storage system, the external storage interface 2226 can, with the aid of the adapter 2258 or modem 2260, manage storage provided by the cloud storage system as it would other types of external storage. For instance, the external storage interface 2226 can be configured to provide access to cloud storage sources as if those sources were physically connected to the computer 2202.

The computer 2202 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

FIG. 23 is a schematic block diagram of a sample computing environment 2300 with which the disclosed subject matter can interact. The sample computing environment 2300 includes one or more client(s) 2310. The client(s) 2310 can be hardware or software (e.g., threads, processes, computing devices). The sample computing environment 2300 also includes one or more server(s) 2330. The server(s) 2330 can also be hardware or software (e.g., threads, processes, computing devices). The servers 2330 can house threads to perform transformations by employing one or more embodiments as described herein, for example. One possible communication between a client 2310 and a server 2330 can be in the form of a data packet adapted to be transmitted between two or more computer processes. The sample computing environment 2300 includes a communication framework 2350 that can be employed to facilitate communications between the client(s) 2310 and the server(s) 2330. The client(s) 2310 are operably connected to one or more client data store(s) 2320 that can be employed to store information local to the client(s) 2310. Similarly, the server(s) 2330 are operably connected to one or more server data store(s) 2340 that can be employed to store information local to the servers 2330.

Various embodiments may be a system, a method, an apparatus or a computer program product at any possible technical detail level of integration. The computer program product can include a computer readable storage medium (or media) having computer readable program instructions thereon for causing a processor to carry out aspects of various embodiments. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various embodiments can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform various aspects.

Various aspects are described herein with reference to flowchart illustrations or block diagrams of methods, apparatus (systems), and computer program products according to various embodiments. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that various aspects can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various non-limiting aspects are described in the following examples.

EXAMPLE 1: A system can comprise: a processor that executes computer-executable components stored in a non-transitory computer-readable memory, wherein the computer-executable components can comprise: an access component that can access a mass analyzer; and a calibration component that can calibrate the mass analyzer, based on predicting an initial time and an initial phase of the mass analyzer via at least one fitted model.

EXAMPLE 2: The system of any preceding example can be implemented, wherein the calibration component can predict the initial time and the initial phase based on feeding a user-selected operational parameter configuration of the mass analyzer as input to the at least one fitted model.

EXAMPLE 3: The system of any preceding example can be implemented, wherein the calibration component can: cause the mass analyzer to perform a plurality of scans at a respectively corresponding plurality of operational parameter configurations, thereby yielding a plurality of reference time-domain signals; and compute, via application of a Fourier transform and sinusoid construction to the plurality of reference time-domain signals, a respective initial time and a respective initial phase for each of the plurality of operational parameter configurations.

EXAMPLE 4: The system of any preceding example can be implemented, wherein the calibration component can: generate a plurality of parameter-vs-initial-time plots and a plurality of parameter-vs-initial-phase plots, based on the respective initial time and respective initial phase for each of the plurality of operational parameter configurations; and generate the at least one fitted model using coefficients that are derived from the plurality of parameter-vs-initial-time plots and the plurality of parameter-vs-initial-phase plots.

EXAMPLE 5: The system of any preceding example can be implemented, wherein the plurality of operational parameter configurations can be extremities or midpoints within an operational parameter space of the mass analyzer, and wherein the coefficients can be slopes exhibited by the plurality of parameter-vs-initial-time plots and the plurality of parameter-vs-initial-phase plots.

EXAMPLE 6: The system of any preceding example can be implemented, wherein the at least one fitted model can exhibit an artificial intelligence architecture, and wherein the calibration component can: train the at least one fitted model, using the respective initial time and respective initial phase for each of the plurality of operational parameter configurations as annotated training data.

EXAMPLE 7: The system of any preceding example can be implemented, wherein the calibration component can: cause the mass analyzer to perform a calibrant scan using the initial time and initial phase predicted by the at least one fitted model and using frequency-ratio and mass-ratio matching, thereby yielding a frequency-to-mass coefficient.

EXAMPLE 8: The system of any preceding example can be implemented, wherein the computer-executable components can include: an execution component that can cause the mass analyzer to perform a scan on a sample, where resultant data produced by such scan is processed via an enhanced Fourier transform signal processing protocol using the initial time, the initial phase, and the frequency-to-mass coefficient.

EXAMPLE 9: The system of any preceding example can be implemented, wherein the calibration component can predict a respective initial time and a respective initial phase for each of a plurality of mass ranges associated with the mass analyzer.

In various embodiments, any combination or combinations of examples 1-9 can be implemented.

EXAMPLE 10: A computer-implemented method can comprise: accessing, by a device operatively coupled to a processor, a mass analyzer; and calibrating, by the device, the mass analyzer, based on predicting an initial time and an initial phase of the mass analyzer via at least one fitted model.

EXAMPLE 11: The computer-implemented method of any preceding example can be implemented, wherein the device can predict the initial time and the initial phase based on feeding a user-selected operational parameter configuration of the mass analyzer as input to the at least one fitted model.

EXAMPLE 12: The computer-implemented method of any preceding example can be implemented, further comprising: causing, by the device, the mass analyzer to perform a plurality of scans at a respectively corresponding plurality of operational parameter configurations, thereby yielding a plurality of reference time-domain signals; and computing, by the device and via application of a Fourier transform and sinusoid construction to the plurality of reference time-domain signals, a respective initial time and a respective initial phase for each of the plurality of operational parameter configurations.

EXAMPLE 13: The computer-implemented method of any preceding example can be implemented, further comprising: generating, by the device, a plurality of parameter-vs-initial-time plots and a plurality of parameter-vs-initial-phase plots, based on the respective initial time and respective initial phase for each of the plurality of operational parameter configurations; and generating, by the device, the at least one fitted model using coefficients that are derived from the plurality of parameter-vs-initial-time plots and the plurality of parameter-vs-initial-phase plots.

EXAMPLE 14: The computer-implemented method of any preceding example can be implemented, wherein the plurality of operational parameter configurations can be extremities or midpoints within an operational parameter space of the mass analyzer, and wherein the coefficients can be slopes exhibited by the plurality of parameter-vs-initial-time plots and the plurality of parameter-vs-initial-phase plots.

EXAMPLE 15: The computer-implemented method of any preceding example can be implemented, wherein the at least one fitted model can exhibit an artificial intelligence architecture, and further comprising: training, by the device, the at least one fitted model, using the respective initial time and respective initial phase for each of the plurality of operational parameter configurations as annotated training data.

EXAMPLE 16: The computer-implemented method of any preceding example can be implemented, further comprising: causing, by the device, the mass analyzer to perform a calibrant scan using the initial time and initial phase predicted by the at least one fitted model and using frequency-ratio and mass-ratio matching, thereby yielding a frequency-to-mass coefficient.

EXAMPLE 17: The computer-implemented method of any preceding example can be implemented, further comprising: causing, by the device, the mass analyzer to perform a scan on a sample, where resultant data produced by such scan is processed via an enhanced Fourier transform signal processing protocol using the initial time, the initial phase, and the frequency-to-mass coefficient.

EXAMPLE 18: The computer-implemented method of any preceding example can be implemented, wherein the device can predict a respective initial time and a respective initial phase for each of a plurality of mass ranges associated with the mass analyzer.

In various embodiments, any combination or combinations of examples 10-18 can be implemented.

EXAMPLE 19: A computer program product for facilitating rapid mass analyzer calibration via initial time and phase prediction can comprise a non-transitory computer-readable memory having program instructions embodied therewith. In various aspects, the program instructions can be executable by a processor to cause the processor to: access a mass analyzer; and calibrate the mass analyzer, based on predicting an initial time and an initial phase of the mass analyzer via at least one fitted model.

EXAMPLE 20: The computer program product of any preceding example can be implemented, wherein the processor can predict the initial time and the initial phase based on feeding a user-selected operational parameter configuration of the mass analyzer as input to the at least one fitted model.

In various embodiments, any combination or combinations of examples 19-20 can be implemented.

In various embodiments, any combination or combinations of examples 1-20 can be implemented.

What is claimed is:

1. A system, comprising:
a processor that executes computer-executable components stored in a non-transitory computer-readable memory, wherein the computer-executable components comprise:
an access component that accesses a mass analyzer; and
a calibration component that calibrates the mass analyzer, based on predicting an initial time and an initial phase of the mass analyzer via at least one fitted model.

2. The system of claim 1, wherein the calibration component predicts the initial time and the initial phase based on feeding a current operational parameter configuration of the mass analyzer as input to the at least one fitted model.

3. The system of claim 2, wherein the calibration component:
causes the mass analyzer to perform a plurality of scans at a respectively corresponding plurality of operational parameter configurations, thereby yielding a plurality of reference time-domain signals; and
computes, via application of a Fourier transform and sinusoid construction to the plurality of reference time-domain signals, a respective initial time and a respective initial phase for each of the plurality of operational parameter configurations.

4. The system of claim 3, wherein the calibration component:
generates a plurality of parameter-vs-initial-time plots and a plurality of parameter-vs-initial-phase plots, based on the respective initial time and respective initial phase for each of the plurality of operational parameter configurations; and
generates the at least one fitted model using coefficients that are derived from the plurality of parameter-vs-initial-time plots and the plurality of parameter-vs-initial-phase plots.

5. The system of claim 4, wherein the plurality of operational parameter configurations are extremities or midpoints within an operational parameter space of the mass analyzer, and wherein the coefficients are slopes exhibited by the plurality of parameter-vs-initial-time plots and the plurality of parameter-vs-initial-phase plots.

6. The system of claim 3, wherein the at least one fitted model exhibits an artificial intelligence architecture, and wherein the calibration component:
trains the at least one fitted model, using the respective initial time and respective initial phase for each of the plurality of operational parameter configurations as annotated training data.

7. The system of claim 1, wherein the calibration component:
causes the mass analyzer to perform a calibrant scan using the initial time and initial phase predicted by the at least one fitted model and using frequency-ratio and mass-ratio matching, thereby yielding a frequency-to-mass coefficient.

8. The system of claim 7, wherein the computer-executable components further comprise:
an execution component that causes the mass analyzer to perform a scan on a sample, where resultant data produced by such scan is processed via an enhanced Fourier transform signal processing protocol using the initial time, the initial phase, and the frequency-to-mass coefficient.

9. The system of claim 1, wherein the calibration component predicts a respective initial time and a respective initial phase for each of a plurality of mass ranges associated with the mass analyzer.

10. A computer-implemented method, comprising:
accessing, by a device operatively coupled to a processor, a mass analyzer; and
calibrating, by the device, the mass analyzer, based on predicting an initial time and an initial phase of the mass analyzer via at least one fitted model.

11. The computer-implemented method of claim 10, wherein the device predicts the initial time and the initial phase based on feeding a current operational parameter configuration of the mass analyzer as input to the at least one fitted model.

12. The computer-implemented method of claim 11, further comprising:
causing, by the device, the mass analyzer to perform a plurality of scans at a respectively corresponding plurality of operational parameter configurations, thereby yielding a plurality of reference time-domain signals; and
computing, by the device and via application of a Fourier transform and sinusoid construction to the plurality of reference time-domain signals, a respective initial time and a respective initial phase for each of the plurality of operational parameter configurations.

13. The computer-implemented method of claim 12, further comprising:
generating, by the device, a plurality of parameter-vs-initial-time plots and a plurality of parameter-vs-initial-phase plots, based on the respective initial time and respective initial phase for each of the plurality of operational parameter configurations; and
generating, by the device, the at least one fitted model using coefficients that are derived from the plurality of parameter-vs-initial-time plots and the plurality of parameter-vs-initial-phase plots.

14. The computer-implemented method of claim 13, wherein the plurality of operational parameter configurations are extremities or midpoints within an operational parameter space of the mass analyzer, and wherein the coefficients are slopes exhibited by the plurality of parameter-vs-initial-time plots and the plurality of parameter-vs-initial-phase plots.

15. The computer-implemented method of claim 12, wherein the at least one fitted model exhibits an artificial intelligence architecture, and further comprising:
training, by the device, the at least one fitted model, using the respective initial time and respective initial phase for each of the plurality of operational parameter configurations as annotated training data.

16. The computer-implemented method of claim 10, further comprising:
causing, by the device, the mass analyzer to perform a calibrant scan using the initial time and initial phase predicted by the at least one fitted model and using frequency-ratio and mass-ratio matching, thereby yielding a frequency-to-mass coefficient.

17. The computer-implemented method of claim 16, further comprising:
causing, by the device, the mass analyzer to perform a scan on a sample, where resultant data produced by such scan is processed via an enhanced Fourier transform signal processing protocol using the initial time, the initial phase, and the frequency-to-mass coefficient.

18. The computer-implemented method of claim 10, wherein the device predicts a respective initial time and a respective initial phase for each of a plurality of mass ranges associated with the mass analyzer.

19. A computer program product for facilitating rapid mass analyzer calibration via initial time and phase prediction, the computer program product comprising a non-transitory computer-readable memory having program instructions embodied therewith, the program instructions executable by a processor to cause the processor to:
access a mass analyzer; and
calibrate the mass analyzer, based on predicting an initial time and an initial phase of the mass analyzer via at least one fitted model.

20. The computer program product of claim 19, wherein the processor predicts the initial time and the initial phase based on feeding a current operational parameter configuration of the mass analyzer as input to the at least one fitted model.
